(19) United States
(12) Patent Application Publication
(10) Pub. No.: US 2006/0146026 A1
(43) Pub. Date: Jul. 6, 2006

(54) Multifunctional keys and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 11/024,425

(22) Filed: Dec. 30, 2004

(51) Int. Cl. G09G 5/00

(52) U.S. Cl. 345/168

(57) ABSTRACT

The present invention generally relates to exemplary aspects and their embodiments of various keys, various key units incorporating such keys, and various key assemblies incorporating such keys and/or key units. More particularly, such a key of the present invention may preferably include multiple sections (or parts) each of which may be assigned or associated with a different character such as a numeral, an alphabet, and/or a symbol. The key unit of the present invention may include mechanical and/or electrical units each of which may be coupled to one of such sections (or parts) of the key and to allow the user to represent such a character assigned to one of such sections (or parts) simply by applying input force thereto. Therefore, such a key unit of the present invention may advantageously allow the user to select any of multiple characters assigned to different sections (or parts) of a single key by providing single input force to any of such sections (or parts), without having to require such an user to manipulate another section of another key. Moreover, such a key unit of this invention may advantageously allow the user to consecutively select all of multiple characters assigned to different sections (or parts) of the single key by consecutively applying input forces only to different sections (or parts) of such a key, without requiring the user to manipulate another section (or part) of another key during manipulation of such sections (or parts) of such a single key and/or without necessitating the user to wait for a preset period to select one of multiple characters assigned to such a single key. The key assembly of the present invention may incorporate such keys and/or key units of the present invention arranged according to preset patterns for the purpose of allowing the user to select each of the character assigned to various sections (or parts) of each of the keys by applying the input forces only to desired sections (or parts) but not to other auxiliary keys thereof.

The present application claims a benefit of an earlier invention date pertinent to the Disclosure Document which has been deposited in the U.S. Patent and Trademark Office by the same Applicant on Dec. 31, 2002 under the Disclosure Document Deposit Program of the Office, which is entitled as “Multifunctional Keys and Methods,” and bears a Ser. No. 523,962, an entire portion of which is to be incorporated by reference herein.

### FIELD OF THE INVENTION

The present invention generally relates to various keys, various key units incorporating such keys, and various key assemblies incorporating such keys and/or key units. More particularly, such a key of the present invention may preferably include multiple sections (or parts) each of which may be assigned (or associated) with a different character such as a numeral, an alphabet, and/or a symbol. Such a key unit of the present invention may include mechanical and/or electrical units each of which may be coupled to one of such sections (or parts) of the key and to allow the user to represent such a character assigned to one of such sections (or parts) by applying input force thereto. Accordingly, such a key unit of the present invention may advantageously allow the user to select any of multiple characters assigned to different sections (or parts) of a single key by providing single input force to any of such sections (or parts), without having to manipulate other sections of other keys. Moreover, such a key unit of this invention may advantageously allow the user to select all of multiple characters assigned to different sections (or parts) of the single key consecutively by applying input forces only onto different sections (or parts) of such a key consecutively, without requiring the user to manipulate other sections (or parts) of other keys during manipulation of such sections (or parts) of such a single key. Such a key assembly of the present invention may incorporate such keys and/or key units of the present invention arranged according to preset patterns for the purpose of allowing the user to select each character assigned to various sections (or parts) of various keys by applying such input forces only to desired sections (or parts) but not to other auxiliary keys thereof. Various exemplary aspects and/or embodiments of such keys, key units, and/or key assemblies of the present invention will now be provided hereinafter in reference to accompanied figures.

### BACKGROUND OF THE INVENTION

Various keypads have been in use to represent numerals, alphabets, and symbols of different languages. Although a keypad with less keys is generally preferred, such a keypad typically requires about thirty to fifty keys so as to represent such numerals, alphabets, and symbols. For example, the English language may provide twenty-six alphabets each of which may be either an upper case or a lower case. In addition to such alphabets, the Arabic numeric system carries ten numerals and about ten to twenty symbols are also frequently used. In order to represent each of such seventy to eighty different characters, conventional keypads generally include at least forty keys each of which may be arranged to represent two different characters, i.e., one character in its normal position and another character in its shifted position.

Various keypads of compact or portable devices may afford a smaller number of keys due to their space limitations, where examples of such devices may include mobile phones, data organizers, PDA's, and the like. For example, keypads of conventional mobile phones include twelve alphanumeric keys which are generally arranged in a four-by-three matrix. In order to represent ten numerals and fifty-two alphabets, each of a majority of such keys is generally assigned with a single numeral and three or four alphabets such that one key may be assigned with a numeral “2” and alphabets “A,” “B,” and “C,” another key may be assigned with a numeral “7” and alphabets “P,” “Q,” “R,” and “S,” and the like. When selecting one specific character out of such a numeral and alphabets, an user is required to repeatedly apply input forces to the key which then selects and displays each of such characters on its screen according to a preset order. When the key selects the desired character, the user may then take an appropriate action. Applying the input forces to a single key repeatedly is a cumbersome task and, furthermore, selecting multiple characters assigned to the same key is a time-consuming job. For example, in order to select “P” and “R” consecutively, the user may apply the input force to a key, select “P,” take an action, and then have to wait for a preset period of time before he or she can apply another input force to the key and select “R.” In short, current technology does not allow the user to select any of multiple characters assigned to a key by applying the input force once and for all.

Accordingly, there is a need for a key to which multiple characters may be assigned and with which the user may select each of such multiple characters by applying only a single input force to a specific portion of the key but not to other portions thereof such that the user may manipulate different portions of such a key to represent different characters assigned thereto, without cooperation of any other key. In addition, there is a need for a key assembly which incorporates multiple of such keys to represent various numerals, alphabets, and/or symbols of a specific language.

### SUMMARY OF THE INVENTION

The present invention generally relates to exemplary aspects and their embodiments of various keys, various key units incorporating such keys, and various key assemblies incorporating such keys and/or key units. More particularly, such a key of the present invention may preferably include multiple sections (or parts) each of which may be assigned or associated with a different character such as a numeral, an alphabet, and/or a symbol. The key unit of the present invention may include mechanical and/or electrical units each of which may be coupled to one of such sections (or parts) of the key and to allow the user to represent such a character assigned to one of such sections (or parts) simply by applying input force thereto. Therefore, such a key unit of the present invention may advantageously allow the user to select any of multiple characters assigned to different sections (or parts) of a single key by providing single input force to any of such sections (or parts), without having to require such an user to manipulate another section of another key. Moreover, such a key unit of this invention may advantageously allow the user to consecutively select all of multiple characters assigned to different sections (or parts) of the single key by consecutively applying input forces only to different sections (or parts) of such a key, without requiring the user to manipulate another section (or part) of another key during manipulation of such sections (or parts) of such a single key and/or without necessitating the user to wait for a preset period to select one of multiple characters assigned to such a single key. The key assembly of the present invention may incorporate such keys and/or key units of the present invention arranged according to preset patterns for the purpose of allowing the user to select each of the character assigned to various sections (or parts) of each of the keys by applying the input forces only to desired sections (or parts) but not to other auxiliary keys thereof.

Various keys, key units, and/or key assemblies of the present invention may be used in almost any keyboards and/or keypads for almost any languages. For example, such keys, key units, and key assemblies may be incorporated into keyboards of desktop computers, laptop computers, computers for laboratories, factories, industries, and so on. Such keys, key units, and key assemblies may also be incorporated into keypads for telephones, mobile phones, PDA's, organizers, and the like. Various exemplary aspects and/or embodiments of various keys, key units, and/or key assemblies will now be described.

Various keys, key units, and/or key assemblies of the present invention may readily be applied to those which may involve depression and recoiling of such keys for selecting characters assigned thereto. The keys, key units, and/or key assemblies of the present invention may also be incorporated into conventional electric or electromechanical keys, key units, and/or key assemblies which may only involve touching of at least portions thereof to select such characters. Such keys, key units, and/or key assemblies of the present invention may also be incorporated into keypads for selecting numerals, alphabets, and symbols. Such keys, key units, and/or key assemblies may further be incorporated to keypads for selecting various functions rather than specific numerals, alphabets or symbols, where examples of devices having such keypads may include, but not be limited to, calculators, organizers, control panels, and the like.

In the first aspect of the present invention, various unitary keys may be provided for selecting multiple characters assigned thereto.

In one exemplary embodiment of such a first aspect of the present invention, such an unitary key may include an unitary body defining multiple exposed sections. At least two of the sections may be arranged to be assigned with different characters, and an user may identify each of such at least two of the sections and provide input forces only to one of such at least two of the sections when he or she selects one of the characters which may be arranged to be assigned with such one of such at least two of the sections.

In another exemplary embodiment of such a first aspect of this invention, such an unitary key may include an unitary body defining multiple exposed sections. At least two of the sections may be arranged to be provided with different physical properties on their surfaces so as to provide an user with different sensations, and such at least two of the sections may also be arranged to be assigned with different characters. Therefore, the user may be arranged to identify each of such at least two of the sections through the sensations and to provide input forces only to one of such at least two of the sections when selecting one of the characters which may be arranged to be assigned with such one of such at least two of the sections.

In another exemplary embodiment of such a first aspect of this invention, such an unitary key may include an unitary body defining multiple exposed sections. At least two of the sections may be arranged to have different orientations extending in different angles with respect to each other so as to provide different sensations to an user, and such at least two of the sections may be arranged to be assigned with different characters. Therefore, the user may be arranged to identify each of such at least two of the sections through the sensations and to provide input forces only to one of such at least two of the sections when he or she wants to select one of the characters which is arranged to be assigned with such one of such at least two of the sections.

In another exemplary embodiment of such a first aspect of this invention, such an unitary key may include an unitary body defining multiple exposed sections. At least two of the sections may be arranged to receive different input forces from an user and to generate movements of the body along different paths, and such at least two of the sections may be arranged to be assigned with different characters. Thus, the user may be arranged to identify each of such at least two of the sections, to provide such input forces only to one of such at least two of the sections, and to generate one of the movements when selecting one of the characters which may be arranged to be assigned with such one of such at least two of the sections.

In the second aspect of this invention, various unitary multiple-section keys may be provided to select multiple characters assigned thereto.

In one exemplary embodiment of the second aspect of the present invention, a key may include an unitary body which may define at least two exposed sections over different areas thereof. One of such exposed sections may be arranged to be assigned with a single numeral, whereas the other of such sections may be arranged to be assigned with a single alphabet. Each of such sections may be arranged to receive input force which is applied by an user to at least a portion thereof and to also not respond to another input force applied by the user to another section. Therefore, the user can select one of the numeral and alphabet by applying the input force to one of the sections but not to the other thereof.

In another exemplary embodiment of such a second aspect of the present invention, an unitary key may include an unitary body defining at least three exposed sections over different areas thereof. One of such exposed sections may be arranged to be assigned with a single numeral, whereas each of the rest of such sections may be arranged to be assigned with a single different alphabet. Each of such sections may be arranged to receive input force applied by an user to at least a portion thereof, and to not respond to other input forces applied by the user to other sections. Accordingly, the user can select one of the numeral and alphabets by applying the input force to one of the sections but not to other sections.

In another exemplary embodiment of such a second aspect of the present invention, an unitary key may include an unitary body defining at least four exposed sections over different areas thereof. One of such exposed sections may be arranged to be assigned with a single numeral, whereas each of the rest of such sections may be arranged to be assigned with a single different alphabet. Each of such sections may be arranged to receive input force applied by an user to at least a portion thereof, and to not respond to other input forces applied by the user to other sections. Accordingly, the user can select one of the numeral and alphabets by applying the input force to one of the sections but not to other sections.

In another exemplary embodiment of such a second aspect of the present invention, an unitary key may include an unitary body defining at least five exposed sections over different areas thereof. One of such exposed sections may be arranged to be assigned with a single numeral, whereas each of the rest of such sections may be arranged to be assigned with a single different alphabet. Each of such sections may be arranged to receive input force applied by an user to at least a portion thereof, and to not respond to other input forces applied by the user to other sections. Accordingly, the user can select one of the numeral and alphabets by applying the input force to one of the sections but not to other sections.

Various embodiments of the above first and second aspects of the present invention may also include one or more of the following features.

Such a key may include two, three, four, five or six sections each of which may be assigned with different characters including numerals, alphabets, and/or symbols of various languages, and so on. One of such at least two of the sections may be assigned with a single numeral, whereas each of the rest of such at least two of the sections may be assigned with a single alphabet and/or symbol. One of such at least two of the sections may be assigned with a single symbol, while each of the rest of such at least two of such sections may be assigned with a single alphabet and/or a single different symbol. Such at least two of the sections may be disposed on different areas of the body so that the input forces may be independently applied by the user to the different areas of the body.

Examples of the above properties may include, but not be limited to, elevations of the surfaces, inclinations or angles thereof, textures thereof, shapes such as a number of sides and/or a number of vertices thereof, sizes thereof, orientations thereof, exposed areas thereof, contours thereof, colors thereof, and the like. Such surface properties may include other physical, chemical, and/or electrical properties as long as such properties may facilitate the user to distinguish one section of the key from the rest thereof.

Examples of the foregoing movements may include, but not be limited to, a vertical movement of the section, body, and/or key, a horizontal movement thereof, an angular movements thereof, and the like. In addition, the above movements may include curvilinear translation of the section, body, and/or key, rotation thereof, pivoting thereof, reciprocation thereof, and the like. At least two of the foregoing movements of at least two of such sections of a single key may move the key in at least two different directions. The above paths may be linear, curved, and/or curvilinear. One of the sections may move between a rest position and an active position, where such one of the sections may be disposed in its rest position when the input force is not applied thereto and moved to its active position in response to the input force. Such a key may include at least one recoil unit which may be arranged to return such one of the sections to its rest position from its active position in response to the input force.

Consecutive application of the input forces to such sections without additional manipulation of another key may allow the user to select different characters assigned (or associated) therewith. In other words, consecutive application of the input forces to the sections may allow the user to select the characters assigned to the sections consecutively without cooperation of another key. Each of the sections may operatively couple with at least one circuit capable of generating a different electric signal in response to the input force, thereby producing electric signals designated to the characters assigned to such sections.

In the third aspect of the present invention, various unitary key units may be provided so as to select multiple different characters assigned thereto.

In one exemplary embodiment of the third aspect of the present invention, such an unitary key unit may have an unitary body defining multiple exposed sections. At least two of such sections may be arranged to be disposed in different areas of such a body and assigned with different characters. Each of such at least two of the sections may be arranged to receive different input force applied by an user and to generate a movement from its rest position to its active position in response to the input force. Therefore, the user can select one of such characters by applying the input force to only one of the different areas of the body and to one of such at least two of the sections, but not to the other thereof.

In another exemplary embodiment of the third aspect of the present invention, such an unitary key unit may include an unitary body and at least two recoil units. Such an unitary body may define multiple exposed sections at least two of which may be arranged to be disposed in different areas of the body and to be assigned with different characters, while each of the recoil units may be arranged to form a coupling with only one of such at least two of the sections. Each of such at least two of the sections may be arranged to move from its rest position to its active position in response to input force applied thereto by an user. Each of such at least two recoil units may be arranged to store at least a portion of energy of the input force and to release the portion of the energy in order to return only one of such at least two of the sections from its active position to its rest position upon cessation of such input force. In addition, each of such at least two recoil units may further be arranged to store and to release the portion of the energy when such input force is applied to only one of such at least two of the sections but not to the other thereof, thereby enabling the user to select different characters by manipulating such at least two of the sections and returning such at least two of the sections to their respective rest positions by the recoil units.

In the fourth aspect of the present invention, various unitary key units may also be provided so as to generate electric signals each of which represents one of multiple characters.

In one exemplary embodiment of the fourth aspect of the present invention, an unitary key unit may include an unitary body and at least two circuits. The unitary body may define multiple exposed sections at least two of which may be arranged to be disposed in different areas of such a body and to be assigned with different characters. Each of such circuits may be arranged to couple with only one of such at least two of the sections. Each of such at least two of the sections may be arranged to move from its rest position to its active position responsive to input force applied thereto by an user. Each of such at least two circuits may also be arranged to be activated and to be deactivated as the input force may be applied to only one of such at least two of the sections but not to the other thereof.

Therefore, the use can manipulate such at least two of the sections of a single key in order to activate and to deactivate the circuits and to generate the electric signals each of which may represent one of the characters therethrough.

In another exemplary embodiment of the fourth aspect of the present invention, an unitary key unit may have an unitary body and at least two signal units. Such an unitary body may define multiple exposed sections at least two of which may be arranged to be disposed in different areas of such a body and to be assigned with different characters, while each of the signal units may be arranged to be coupled to only one of such at least two of the sections. Each of such at least two of the sections may be arranged to move from its rest position to its active position in response to input force applied thereto by an user, and each of such at least two signal units may be arranged to generate an electric signal when the input force may be applied to only one of such at least two of the sections but not to another thereof. Therefore, the user can manipulate such at least two of the sections of a single key and to provide the electric signals each of which may represent one of the characters by such signal units.

Various embodiments of the above third and fourth aspects of this invention may include such features which have been described in conjunction with the first and second aspects of the present invention and may also include one or more of the following features.

Consecutive application of the input forces to such sections without additional manipulation of another key may allow the user to select different characters assigned (or associated) therewith. In other words, consecutive application of the input forces to the sections may allow the user to select the characters assigned to the sections consecutively without cooperation of another key. Each of the sections may operatively couple with at least one circuit capable of generating a different electric signal in response to the input force, thereby producing electric signals designated to the characters assigned to such sections.

At least one of the rest and active positions of one of such at least two of the sections may be respectively different from at least one of those of the other of such at least two of the sections. The recoil unit may include at least one of a spring, an elastic material, and the like. The above circuits may be disposed under and/or around such at least two of the sections and may be capable of generating different electric signals each representing different characters.

In the fifth aspect of the present invention, various multi-part keys may be provided in order to select multiple characters assigned thereto.

In one exemplary embodiment of the fifth aspect of the present invention, such a multi-part key may include multiple parts which may be arranged to be clustered in proximity or to be disposed within a preset distance from each other. At least two of such parts may be arranged to be assigned with different characters in order to enable an user to identify each of such at least two of the parts and to apply input force only to one of such at least two of the parts but not to the other thereof when such an user may select only one of the characters assigned to such one of such at least two of the parts.

In another exemplary embodiment of the fifth aspect of the present invention, such a multi-part key may include multiple parts which may be arranged to be clustered in proximity or to be disposed within a preset distance from each other. At least two of such parts may be arranged to be assigned with different characters and to have different physical properties on their surfaces sp as to provide an user with different sensations. Thus, such an embodiment may enable the user to identify each of such at least two of the parts through the sensations and to provide input force to only one of such at least two of the parts but not to the other thereof when selecting only one of the characters assigned to such one of such at least two of the parts.

In another exemplary embodiment of the fifth aspect of the present invention, such a multi-part key may include multiple parts which may be arranged to be clustered in proximity or to be disposed within a preset distance from each other. At least two of such parts may be arranged to be assigned with different characters and to have different orientations extending in different angles with respect to each other in order to provide different sensations to an user. Therefore, such an embodiment may enable the user to identify each of such at least two of the parts through the sensations and to apply input force to only one of such at least two of the parts but not to another thereof when selecting only one of the characters assigned to such one of such at least two of the parts.

In another exemplary embodiment of the fifth aspect of the present invention, such a multi-part key may include multiple parts which may be arranged to be clustered in proximity or disposed within a preset distance from each other. At least two of such parts may be arranged to be assigned with different characters, to receive (different) input forces from an user, and then to generate (different) movements thereof in different paths. Therefore, such an embodiment may enable the user to identify each of such at least two of the parts, to apply the input force only to one of such at least two of the parts, and to generate one of the movements thereof when selecting one of the characters assigned to such one of such at least two of the parts.

In the sixth aspect of the present invention, various multi-part keys may also be provided with at least two parts.

In one exemplary embodiment of the sixth aspect of the present invention, a multi-part key may include at least two parts which may be arranged to be clustered in proximity or to be disposed within a preset distance from each other. One of such exposed parts may be arranged to be assigned with a single numeral, and the other of such parts may be arranged to be assigned with a single alphabet. Each of such parts may also be arranged to receive input force applied to at least a portion thereof by an user and to not respond to other input forces applied by the user to other sections. Thus, such an embodiment may enable the user to select one of the numeral and alphabet through applying the input force to only one of such parts but not to the other thereof.

In another exemplary embodiment of the sixth aspect of the present invention, a multi-part key may include at least three parts which may be arranged to be clustered in proximity or to be disposed within a preset distance from each other. One of the exposed parts may be arranged to be assigned with a single numeral, whereas the rest of such parts may be arranged to be assigned with different alphabets. Each of such parts may be arranged to receive input force applied by an user to at least a portion thereof and to not respond to other input forces applied to the rest of such parts by the user. Accordingly, such an embodiment may enable the user to select one of the numeral and alphabets by applying the input force to only one of such parts but not to the rest thereof.

In another exemplary embodiment of the sixth aspect of the present invention, a multi-part key may include at least four parts which may be arranged to be clustered in proximity or to be disposed within a preset distance from each other. One of the exposed parts may be arranged to be assigned with a single numeral, whereas the rest of such parts may be arranged to be assigned with different alphabets. Each of such parts may be arranged to receive input force applied by an user to at least a portion thereof and to not respond to other input forces applied to the rest of such parts by the user. Accordingly, such an embodiment may enable the user to select one of the numeral and alphabets by applying the input force to only one of such parts but not to the rest thereof.

In another exemplary embodiment of the sixth aspect of the present invention, a multi-part key may include at least five parts which may be arranged to be clustered in proximity or to be disposed within a preset distance from each other. One of the exposed parts may be arranged to be assigned with a single numeral, whereas the rest of such parts may be arranged to be assigned with different alphabets. Each of such parts may be arranged to receive input force applied by an user to at least a portion thereof and to not respond to other input forces applied to the rest of such parts by the user. Accordingly, such an embodiment may enable the user to select one of the numeral and alphabets by applying the input force to only one of such parts but not to the rest thereof.

Various embodiments of the above fifth and sixth aspects of the present invention may include one or more of the following features.

Such a key may include two, three, four, five or six parts each of which may be assigned with different characters including numerals, alphabets, and/or symbols of various languages, and the like. One of such at least two of the parts may be assigned with a single numeral, while each of the rest of such at least two of the parts may be assigned with a single alphabet and/or symbol. One of such at least two of the parts may be assigned with a single symbol, while each of the rest of such at least two of such parts may be assigned with a single alphabet and/or a single different symbol. Such at least two of the parts may be disposed on different areas of the key so that the input forces may be independently applied by the user to the different areas of the key.

Examples of the above properties may include, but not be limited to, elevations of the surfaces, inclinations or angles thereof, textures thereof, shapes such as a number of sides and/or a number of vertices thereof, sizes thereof, orientations thereof, exposed areas thereof, contours thereof, colors thereof, and the like. Such surface properties may include other physical, chemical, and/or electrical properties as long as such properties may facilitate the user to distinguish one part of the key from the rest thereof.

Examples of the foregoing movements may include, but not be limited to, a vertical movement of such a part and/or key, a horizontal movement thereof, an angular movement thereof, and the like. In addition, the above movements may also include curvilinear translation of the part and/or key, rotation thereof, pivoting thereof, reciprocation thereof, and the like. At least two of the foregoing movements of at least two of such parts of a single key may move the key in at least two different directions. The foregoing paths may be linear, curved, and/or curvilinear. One of the parts may move between a rest position and an active position, where such one of the parts may be disposed in its rest position when the input force is not applied thereto and may be moved to its active position in response to such input force. Such a key may also include at least one recoil unit which may be arranged to return such one of the parts to its rest position from its active position in response to the input force.

Consecutive application of the input forces to such parts without additional manipulation of the other key may enable the user to select different characters assigned (or associated) therewith. In other words, consecutive application of the input forces to the parts may allow the user to select the characters assigned to the parts consecutively without cooperation of another key. Each of the parts may also operatively couple with at least one circuit capable of generating a different electric signal in response to the input force, thereby producing electric signals designated to the characters assigned to such parts.

Each of such at least two of the parts may move with respect to the other thereof. Such parts of the key may be disposed closer to each other than other parts of another key. In addition, the parts of the key may be movably enclosed within a housing. The distance between such parts and/or such proximity may refer to a distance within a finger's grasp as defined heretofore. Opposing surfaces of the parts may be contoured to allow individual movements.

One of such parts may be arranged to move between a rest position and an active position, to be disposed in the rest position as the input force is not applied thereto, and to be moved to the active position in response to the input force. The key may further include at least one recoil unit arranged to return such one of the parts to its rest position from its active position after the input force is applied.

In the seventh aspect of the present invention, various multi-part key units may be provided in order to selecting multiple different characters assigned thereto.

In one exemplary embodiment of the seventh aspect of the present invention, such a multi-part key unit may have multiple parts which may be arranged to be clustered in proximity or to be disposed within a preset distance from each other. At least two of such parts may be arranged to be assigned with different characters and to be disposed in different areas of the key. Each of such at least two of the parts may be arranged to receive different input force applied by an user and then to generate a movement from its rest position to its active position in response to the input force. Accordingly, this embodiment may enable the user to select one of the characters by applying such input force to only one of such at least two of the parts and not to the other thereof.

In another exemplary embodiment of the seventh aspect of the present invention, such a multi-part key unit may include multiple parts and at least two recoil units. The parts may be arranged to be clustered in proximity or within a preset distance from each other. At least two of such parts may be arranged to be assigned with different characters and to be disposed over different areas of the key, while each of such recoil units may be arranged to form a coupling with only one of such at least two of the parts. Each of such at least two of the parts may be arranged to move from a rest position to an active position thereof in response to input force applied thereto by an user, while each of such at least two recoil units may be arranged to store at least a portion of energy of the input force and then to release the portion of the energy so as to return only one of such at least two of the parts from its active position to its rest position upon cessation of the application of the input force. Each of such at least two recoil units may be arranged to store and release the portion of such energy when the input force is applied to only one of such at least two of the parts but not to the other thereof. Accordingly, such an embodiment may enable the user to select different characters by manipulating such at least two of the parts and then by returning such at least two of the parts to their rest positions through the recoil units.

In the eighth aspect of the present invention, various multi-part key units may also be provided for generating electric signals for multiple characters assigned thereto.

In one exemplary embodiment of the eighth aspect of the present invention, a multi-part key unit may include multiple parts and at least two circuits, where such multiple parts may be arranged to be clustered in proximity or disposed within a preset distance from each other, whereas each of such at least two circuits may be arranged to couple with only one of such at least two of such parts. Such at least two of the parts may also be arranged to be assigned with different characters and disposed in different areas of the key. Each of such at least two of the parts may be arranged to move from a rest position to an active position thereof in response to input force applied thereto by an user. Each of such at least two circuits may be arranged to be activated and to be deactivated as the input force is applied to only one of such at least two of the parts but not to the other thereof. Accordingly, such an embodiment may enable the user to select one of the characters by applying the input force to only one of such at least two of the parts but not to the other thereof, to activate only one of such circuits, and to generate the electric signal which represents such one of the characters through such one of the circuits.

In another exemplary embodiment of the eighth aspect of the present invention, a multi-part key unit may include multiple parts and at least two signal units. Such multiple parts may be arranged to be clustered in proximity or within a preset distance from each other and at least two of the parts may be arranged to be assigned with different characters and disposed in different areas of the key. Each of at least two signal units may be arranged to be coupled to only one of such at least two of the parts. Each of such at least two of the parts may also be arranged to move from a rest position to an active position thereof in response to input force applied thereto by an user, while each of such at least two signal units may be arranged to generate an electric signal when the input force is applied to only one of such at least two of the parts but not to the other thereof. Accordingly, such an embodiment may enable the user to select one of the characters by applying the input force to only one of such at least two of such parts but not to the other thereof and to generate the electric signal which may represent such one of the characters by one of the signal units.

Various embodiments of the seventh and eighth aspects of the present invention may include the features which have been described in conjunction with the fifth and sixth aspects of the present invention and may also include one or more of the following features.

At least one of the rest and active positions of one of such at least two of the parts may also be respectively different from at least one of those of the other of such at least two of the parts. The recoil unit may include a spring, an elastic material, and so on. The circuits may be disposed under or around such at least two of the sections. Such circuits may be capable of providing different electric signals each representing different characters.

In the ninth aspect of the present invention, various key assemblies may further be provided in order to expressing multiple characters assigned to each key thereof.

In one exemplary embodiment of the ninth aspect of the present invention, a key assembly may include multiple keys which may be arranged in a preset number of rows and also in a preset number of columns. Each of at least two of the keys may be arranged to have at least two exposed sections (or parts) each of which may be arranged to be disposed over different areas and to be assigned (or associated) with a different character. Such at least two sections (or parts) of each of at least two of such keys may be arranged to receive different input forces applied thereto by an user. Therefore, this embodiment may enable the user to apply the input force only to one of such at least two sections (or parts) but not to the other thereof when selecting one of such characters arranged to be assigned to such one of such at least two sections (or parts).

In another exemplary embodiment of the ninth aspect of the present invention, a key assembly may include multiple keys which may be arranged in a preset number of rows and in a preset number of columns. Each of at least two of the keys may be arranged to have at least two exposed sections (or parts) each of which may be arranged to be disposed over different areas and to be assigned (or associated) with a different character. Such at least two sections (or parts) of each of at least two of such keys may be arranged to have different physical properties on surfaces thereof to provide an user with different sensations. Such at least two sections (or parts) may also be arranged to receive different input forces applied thereto by the user. Accordingly, this embodiment may enable the user to identify each of such at least two sections through the sensations and to apply the input force only to one of such at least two sections (or parts) but not to the other thereof when selecting one of such characters arranged to be assigned to such one of such at least two sections (or parts).

In another exemplary embodiment of the ninth aspect of the present invention, a key assembly may include multiple keys which may be arranged in a preset number of rows and in a preset number of columns. Each of at least two of the keys may be arranged to have at least two exposed sections (or parts) each of which may be arranged to be disposed over different areas and to be assigned (or associated) with a different character. Such at least two sections (or parts) of each of at least two of the keys may be arranged to have different orientations extending in different angles with respect to each other in order to give an user different sensations. Such at least two sections (or parts) may be arranged to receive different input forces applied thereto by the user. Therefore, this embodiment may enable the user to identify each of such at least two sections (or parts) by the sensations and to apply such input force only to one of such at least two sections (or parts) but not to the other thereof when selecting one of the characters assigned to such one of such at least two sections (or parts).

In another exemplary embodiment of the ninth aspect of the present invention, a key assembly may include multiple keys which may be arranged in a preset number of rows and in a preset number of columns. Each of at least two of the keys may be arranged to have at least two exposed sections (or parts) each of which may be arranged to be disposed over different areas and to be assigned (or associated) with a different character. Such at least two sections (or parts) of each of at least two of the keys may also be arranged to receive different input forces from an user and then to generate movements along different paths. Accordingly, this embodiment may enable the user to identify each of such at least two sections (or parts), to provide such input forces only to one of such at least two sections (or parts), and then to generate one of the movements when selecting one of the characters which may be arranged to be assigned to such one of such at least two sections (or parts).

Various embodiments of the ninth aspect of this invention may also include one or more of the features which have been described in conjunction with the first to eighth aspects of this invention.

In the tenth aspect of the present invention, various key assemblies may also be provided for expressing multiple characters assigned thereto.

In one exemplary embodiment of the tenth aspect of this invention, a key assembly may include multiple keys which may be arranged in a preset number of rows and in a preset number of columns. Each of at least two of the keys may be arranged to include at least two exposed sections (or parts) which may be arranged to be disposed in different areas of the key and to be assigned with different characters. Such at least two sections (or parts) of each of such at least two of the keys may also be arranged to receive different input forces applied by an user and to generate movements from their rest positions to their active positions in response to the input forces. Therefore, this embodiment may enable the user to apply the input force to only one of such at least two sections (or parts) but not to the other of such at least two sections (or parts) when selecting one of the characters which may be assigned to such one of such at least two sections (or parts).

In another exemplary embodiment of the tenth aspect of the present invention, a key assembly may include multiple keys and at least two recoil units. Such multiple keys may be arranged in preset numbers of rows and columns, while each of such at least two recoil units may be arranged to form an operative coupling with only one of such at least two of the sections (or parts). Each of at least two of such keys may be arranged to include at least two exposed sections (or parts) which may be arranged to be disposed in different areas thereof and to be also assigned with different characters. Such at least two sections (or parts) may be arranged to move from rest positions to active positions thereof in response to different input forces applied by an user. Each of such at least two recoil units may be arranged to store at least a portion of energy of the input force and then to release the portion of the energy so as to return only one of such at least two sections (or parts) from the active position to the rest position upon termination of application of the input force. In addition, each of such at least two recoil units may be arranged to store and release the portion of the energy when the input force is applied to only one of such at least two sections (or parts) but not to the other thereof. Thus, this embodiment may enable the user to apply the input force to only one of such at least two sections (or parts) but not to the other thereof when selecting one of the characters assigned to such one of such at least two sections (or parts) and returning such one of such at least two sections (or parts) to its rest position by one of the recoil units coupled to such one of such at least two sections (or parts).

In the eleventh aspect of the present invention, various key assemblies may also be provided for generating multiple electric signals for another plurality of characters assigned thereto.

In one exemplary embodiment of the eleventh aspect of the present invention, a key assembly may include multiple keys and at least two circuits. Such keys may be arranged in preset numbers of rows and columns, and each of such at least two circuits may be arranged to be coupled to only one of such at least two of the sections. Each of at least two of the keys may also be arranged to include at least two exposed sections (or parts) which may be arranged to be disposed over different areas thereof and to be assigned with different characters. Such at least two sections (or parts) may be arranged to move from rest positions to active positions thereof in response to different input forces applied by an user. Each of such at least two circuits may also be arranged to be activated when the input force is applied to only one of such at least two sections (or parts) but not to the other thereof. Therefore, this embodiment may enable the user to provide the input force to only one of such at least two sections (or parts) but not to the other thereof when selecting one of the characters which may be assigned to such one of such at least two sections (or parts) and then providing the electric signal which may represent such one of the characters.

In another exemplary embodiment of the eleventh aspect of this invention, a key assembly may include multiple keys and at least two signal units. Such keys may be arranged in preset numbers of rows and columns, and each of such at least two signal units may be arranged to be coupled to only one of such at least two of the sections. Each of at least two of the keys may be arranged to include at least two exposed sections (or parts) which may be arranged to be disposed over different areas thereof and to be assigned with different characters. Such at least two sections (or parts) may be arranged to move from rest positions to active positions thereof in response to input forces applied by an user. Each of such at least two signal units may further be arranged to generate an electric signal when the input force is applied to only one of such at least two sections (or parts) but not to the other thereof. Therefore, such an embodiment may enable the user to apply the input signal to only one of such at least two sections (or parts) but not to the other thereof when the user may select one of the characters assigned to such one of such at least two sections (or parts) and generating the electric signal representing such one of the characters.

Various embodiments of the ninth aspect of this invention may also include one or more of the features which have been described in conjunction with the first to eighth aspects of this invention.

In the twelfth aspect of the present invention, various key assemblies may further be provided for representing multiple characters such as multiple numerals, alphabets, and/or symbols assigned to various keys thereof.

In one exemplary embodiment of the twelfth aspect of this invention, a key assembly may have multiple keys which may be arranged in multiple rows and multiple columns and each of which may be arranged to define multiple sections (or parts) therein or thereon, in which a total number of such keys may be less than a total number of such characters. Such numerals may be grouped into first multiple sets each of which may be assigned to one of the first multiple of such sections (or parts), whereas the alphabets and/or symbols may be grouped into second multiple of sets each of which may also be assigned to one of the second multiple of the sections. At least one of such keys having at least two sections (or parts) assigned with both of such first and second sets may also be arranged to receive different input forces by an user consecutively and to be capable of representing all of the characters assigned thereto without requiring the user to manipulate any of the keys other than such at least one of the keys itself.

In another exemplary embodiment of the twelfth aspect of this invention, such a key assembly may include multiple keys which may be arranged into positions of elements of a four-by-three matrix and each of which may be arranged to define multiple sections (or parts) therein or thereon, where a total number of such keys may be arranged to be at most twelve. Each of a first number of the keys may be arranged to include at least one of such sections (or parts) assigned with one numeral, while each of a second number of the keys may be arranged to have at least one of the sections (or parts) assigned with one of an alphabet and a symbol. At least one of the keys with at least two sections (or parts) which are assigned with at least two of the characters may also be arranged to receive different input forces each consecutively applied to such at least two sections (or parts) by an user and to be capable of representing all of such at least two of the characters which may be assigned thereto without requiring the user to manipulate any of the keys other than such at least one of such keys itself.

In the thirteenth aspect of the present invention, various key assemblies may also be provided for representing multiple characters including multiple numerals from 0 to 9 and multiple alphabets from A to Z assigned thereto.

In one exemplary embodiment of the thirteenth aspect of the present invention, a key assembly may include multiple keys which may be arranged into positions of elements of a four-by-three matrix. Each of the keys may be arranged to have multiple sections (or parts) therein or thereon, where each of at least two of such sections (or parts) may be assigned with one of a single numeral and a single alphabet and where a total number of the keys may be arranged to be at most twelve. Each of a first number of the keys may be arranged to have one of the sections (or parts) assigned with one of the numerals according to a first sequence, while each of a second number of the keys may be arranged to include one of the sections (or parts) assigned with at least two of such alphabets according to a second sequence. In addition, each of the keys with at least two sections (or parts) assigned with at least two of the characters may also be arranged to receive different input forces each consecutively applied to the at least two sections (or parts) by an user and to be capable of representing all of such at least two of the characters assigned thereto, without necessitating such an user to manipulate any of the keys other than the each of the keys itself.

In another exemplary embodiment of the thirteenth aspect of the present invention, such a key assembly may have multiple keys which may be arranged into positions of elements of a four-by-three matrix. Each of the keys may be arranged to define therein or thereon multiple sections (or parts), and each of at least two of the sections (or parts) may also be assigned with one of a single numeral and a single alphabet, where a total number of such keys may be arranged to be at most twelve. Each of the numerals of a first group of 1 to 3, a second group of 4 to 6, and a third group of 7 to 9 may then be sequentially assigned to one of the sections (or parts) of each of the keys placed in a first row, a second row, and a third row, respectively. The numeral 0 may be assigned to one of the sections (or parts) of the keys of a fourth row. Similarly, each of the alphabets of a group from A to F, a second group from G to O, and a third group from P to Z may be sequentially assigned to one of the sections (or parts) of each of the keys of the first row, second row, and third row, respectively. In addition, each of the keys having at least two sections (or parts) which may be assigned with the characters may be arranged to receive different input forces each of which may also be consecutively applied to such at least two sections (or parts) by an user and to be capable of representing all of such at least two of the characters assigned thereto, without requiring the user to manipulate any of the keys other than the each of the keys itself.

In another exemplary embodiment of the thirteenth aspect of the present invention, such a key assembly may have multiple keys which may be arranged into positions of elements of a four-by-three matrix. Each of the keys may be arranged to define therein or thereon multiple sections (or parts), and each of at least two of the sections (or parts) may also be assigned with one of a single numeral and a single alphabet, where a total number of such keys may be arranged to be at most twelve. Each of the numerals of a first group of 1 to 3, a second group of 4 to 6, and a third group of 7 to 9 may then be sequentially assigned to one of the sections (or parts) of each of the keys placed in a first row, a second row, and a third row, respectively. The numeral 0 may be assigned to one of the sections (or parts) of the keys of a fourth row. Similarly, each of the alphabets from a group of A to G, a second group from H to P, a third group from Q to V, and a fourth group from W to Z may then be sequentially assigned to one of the sections (or parts) of each of the keys of the first row, second row, third row, and fourth row, respectively. In addition, each of such keys including at least two sections (or parts) assigned with the characters may be arranged to receive different input forces each applied to such at least two sections (or parts) consecutively by an user and to be also capable of representing all of such at least two of the characters assigned thereto, without having to require the user to manipulate any of the keys other than such each of the keys itself.

In another exemplary embodiment of the thirteenth aspect of the present invention, such a key assembly may have multiple keys which may be arranged into positions of elements of a four-by-three matrix. Each of the keys may be arranged to define therein or thereon multiple sections (or parts), and each of at least two of the sections (or parts) may also be assigned with one of a single numeral and a single alphabet, where a total number of such keys may be arranged to be at most twelve. Each of the numerals of a first group of 1 to 3, a second group of 4 to 6, and a third group of 7 to 9 may then be sequentially assigned to one of the sections (or parts) of each of the keys placed in a first row, a second row, and a third row, respectively. The numeral 0 may be assigned to one of the sections (or parts) of the keys of a fourth row. Similarly, each of the alphabets of a group from A to G, a second group from H to N, a third group from O to U, and a fourth group from V to Z may then be sequentially assigned to one of the sections (or parts) of each of the keys of the first row, second row, third row, and fourth row, respectively. In addition, each of such keys including at least two sections (or parts) assigned with the characters may be arranged to receive different input forces each applied to such at least two sections (or parts) consecutively by an user and to be also capable of representing all of such at least two of the characters assigned thereto, without having to require the user to manipulate any of the keys other than the each of the keys itself.

In another exemplary embodiment of the thirteenth aspect of the present invention, such a key assembly may have multiple keys which may be arranged into positions of elements of a four-by-three matrix. Each of the keys may be arranged to define therein or thereon multiple sections (or parts), and each of at least two of the sections (or parts) may also be assigned with one of a single numeral and a single alphabet, where a total number of such keys may be arranged to be at most twelve. Each of the numerals of a first group of 1 to 3, a second group of 4 to 6, and a third group of 7 to 9 may then be sequentially assigned to one of the sections (or parts) of each of the keys placed in a first row, a second row, and a third row, respectively. The numeral 0 may be assigned to one of the sections (or parts) of the keys of a fourth row. Each of the alphabets of a group of Q, W, E, R, T, Y, U, I, and O, a second group of A, S, D, F, G, H, J, K, and L, and a third group of Z, X, C, V, B, N, and M, may also be sequentially assigned to one of such sections (or parts) of each of the keys of the first row, second row, and third row, respectively. In addition, each of the keys having at least two sections (or parts) assigned with the characters may be arranged to receive different input forces each applied to such at least two sections (or parts) consecutively by an user and to be also capable of representing all of such at least two of the characters assigned thereto, without having to require the user to manipulate any of the keys other than the each of the keys itself.

In another exemplary embodiment of the thirteenth aspect of the present invention, such a key assembly may have multiple keys which may be arranged into positions of elements of a four-by-three matrix. Each of the keys may be arranged to define therein or thereon multiple sections (or parts), and each of at least two of the sections (or parts) may also be assigned with one of a single numeral and a single alphabet, where a total number of such keys may be arranged to be at most twelve. Each of the numerals of a first group of 9 to 7, a second group of 6 to 4, and a third group of 3 to 1 may then be sequentially assigned to one of the sections (or parts) of each of the keys placed in a first row, a second row, and a third row, respectively. The numeral 0 may be assigned to one of the sections (or parts) of the keys of a fourth row. Each of the alphabets of a group of Q, W, E, R, T, Y, U, I, and O, a second group of A, S, D, F, G, H, J, K, and L, and a third group of Z, X, C, V, B, N, and M, may also be sequentially assigned to one of the sections (or parts) of each of the keys of the first row, second row, and third row, respectively. In addition, each of the keys having at least two sections (or parts) assigned with the characters may be arranged to receive different input forces each applied to such at least two sections (or parts) consecutively by an user and to be also capable of representing all of such at least two of the characters assigned thereto, without having to require the user to manipulate any of the keys other than the each of the keys itself.

Various embodiments of the thirteenth aspect of this invention may also include one or more of the features which have been described in conjunction with the first to eighth aspects of the present invention.

In the fourteenth aspect of the present invention, various methods may be provided to select multiple characters by an unitary key.

In one exemplary embodiment of the fourteenth aspect of the present invention, a method may include the steps of defining multiple exposed sections on the key; assigning each of at least two of the sections with a different character, and selecting each of the characters which may be assigned to each of such at least two of the sections by applying input force only to such one of such at least two of the sections but not to the other thereof, without requiring an user to apply another input force to another key.

In another exemplary embodiment of the fourteenth aspect of the present invention, a method may include the steps of defining multiple exposed sections on the key; assigning each of at least two of the sections with a different character; providing each of such at least two of the sections with different physical properties on surfaces thereof, thereby providing an user with different sensations; allowing an user to identify such each of at least two of the sections by the sensations; and selecting each of the characters which is arranged to be assigned to each of such at least two of the sections by applying input force only to the one of such at least two of the sections but not to the other of such at least two of the sections, without requiring an user to apply another input force to another key.

In another exemplary embodiment of the fourteenth aspect of the present invention, a method may include the steps of defining multiple exposed sections on the key; assigning each of at least two of the sections with a different character; arranging the each of such at least two of the sections to have a different orientation with respect to each other; allowing an user to identify the each of at least two of the sections by the orientation; and selecting each of the characters which may be assigned to each of such at least two of the sections by applying input force only to the one of such at least two of the sections but not to the other thereof, without requiring an user to apply another input force to another key.

In another exemplary embodiment of the fourteenth aspect of the present invention, a method may also include the steps of defining multiple exposed sections on the key; assigning each of at least two of the sections with a different character; arranging such each of at least two of the sections to generate movement of the key along a different path in response to a different input force applied by an user; and selecting each of the characters which is assigned to each of such at least two of the sections by applying input force only to the one of such at least two of the sections but not to another thereof and by moving the each of such at least two of the sections along the different path, without requiring an user to apply another input force to another key.

In the fifteenth aspect of the present invention, various methods may be provided for selecting multiple characters including numerals, alphabets, and symbols by an unitary key which may include multiple sections.

In one exemplary embodiment of the fifteenth aspect of the present invention, such a method may include the steps of defining at least two exposed sections in or over different areas of the key; assigning one of such at least two of the sections with a single numeral; assigning the other of such at least two of the sections with a single alphabet; and arranging each of the sections to respond only to input force applied by an user to at least a portion thereof and to not respond to input force applied to the other of the sections, thereby enabling an user to select each of the numeral and alphabet that are assigned to the each of such sections but not other characters assigned to the other thereof.

In another exemplary embodiment of such a fifteenth aspect of the present invention, a method may include the steps of defining at least three exposed sections in or over different areas of the key; assigning one of such at least three of the sections with a single numeral; assigning one of the rest of such at least three of the sections with a single alphabet; and then arranging each of the sections to respond only to input force applied by an user to at least a portion thereof and to not respond to input force applied to the other of the sections, thereby enabling an user to select each of the numeral and alphabet assigned to the each of such sections but not to the other thereof.

In another exemplary embodiment of such a fifteenth aspect of the present invention, a method may include the steps of defining at least four exposed sections in or over different areas of the key; assigning one of such at least four of the sections with a single numeral; assigning one of the rest of such at least four of the sections with a single alphabet; and then arranging each of the sections to respond only to input force applied by an user to at least a portion thereof and to not respond to input force applied to the other of the sections, thereby enabling an user to select each of the numeral and alphabet assigned to the each of such sections but not to the other thereof.

In another exemplary embodiment of such a fifteenth aspect of the present invention, a method may include the steps of defining at least five exposed sections in or over different areas of the key; assigning one of such at least five of the sections with a single numeral; assigning one of the rest of such at least five of the sections with a single alphabet; and then arranging each of such sections to respond only to input force applied by an user to at least a portion thereof and to not respond to input force applied to the other of the sections, thereby enabling an user to select each of the numeral and alphabet assigned to the each of the sections but not to the other thereof.

Various embodiments of the above fourteenth and fifteenth aspects of this invention may also include one or more of the following features.

The defining step may include the step of defining two, three, four, five or six of the sections over or on the key. The defining step may include the steps of disposing at least two of the sections on different areas of the key and independently applying the input forces to the different areas of the key.

The assigning step may also include the steps of assigning one of such sections with a single numeral and assigning each of the rest of the sections with a single alphabet and/or a single symbol. The assigning step may include the steps of assigning one of such sections with a single symbol and assigning each of such rest of the sections with a single alphabet and/or different symbol.

The method may further include the step of providing at least two of the sections with different properties which may include at least one of elevations, inclinations or angles, textures, shapes such as numbers of sides and/or vertices, sizes, orientations, exposed areas, contours, colors, and so on. The moving step may have one or more of the steps such as vertically moving the section and/or key, horizontally moving such, angularly moving such, and so on. The moving step may have one or more of the steps such as translating such a section and/or key along a curvilinear path, rotating or pivoting such therealong, reciprocating such therealong, and the like. The moving step may include the step of moving at least two of such sections along different paths and/or in different directions. The moving step may also include the step of moving one of such sections between its rest position and its active position, where such one of the sections may be disposed in the rest position when the input force is not applied thereto and moved to the active position in response to the input force.

The method may include the step of providing at least one recoil unit arranged to return one of the sections to its rest position from its active position after the input force is applied. The arranging step may include the step of applying the input forces to the sections which are assigned with such characters consecutively without additional manipulation of the other key, thereby allowing the user to select different characters assigned (or associated) therewith. The arranging may further include the step of applying the input forces to the sections assigned with the characters consecutively, thereby allowing the user to select the characters assigned to the sections consecutively without cooperation of another key. Such a method may include the steps of providing multiple circuits each of which may be capable of generating a different electric signal in response to the input force and may operatively couple each of the sections with at least one of the circuits.

In the sixteenth aspect of the present invention, various methods may further be provided for selecting multiple different characters which are assigned to an unitary key unit.

In one exemplary embodiment of the sixteenth aspect of the present invention, a method may include the steps of defining multiple exposed sections in or over different areas of the key; assigning at least two of such sections with different characters; and moving each of such at least two of the sections from its rest position to its active position in response to different input force applied by an user, thereby enabling the user to select one of such characters by applying the input force to one of the different areas of the body and to one of such at least two of the sections.

In another exemplary embodiment of the sixteenth aspect of the present invention, a method may include the steps of defining multiple exposed sections in different areas of the key; assigning at least two of such sections with different characters; providing at least two recoil units for storing and releasing energy; coupling each of such at least two recoil units with one of such at least two of the sections; moving one of such at least two of the sections from the rest position to the active position thereof in response to input force applied by an user while storing at least a portion of energy of such input force by the one of such at least two recoil units coupled to the one of such at least two of such sections, thereby enabling the user to select one of the characters assigned to such one of such at least two of such sections by applying the input force to the one of such at least two of the sections but not to the other thereof; and releasing the portion of the energy by the one of such at least two recoil units, thereby returning the one of such at least two of the sections to the rest position thereof.

In the seventeenth aspect of the present invention, various methods may also be provided for generating electric signals for different characters assigned to an unitary key unit having a key.

In one exemplary embodiment of such a seventeenth aspect of the present invention, a method may include the steps of defining multiple exposed sections in the key; disposing at least two of such sections in different areas of the key; assigning at least two of the sections with different characters; providing at least two circuits capable of being activated by input force applied thereto by an user and capable of generating an electric signal in response to the input force; coupling each of such at least two circuits with only one of such at least two of the sections; and moving one of such at least two of the sections from its rest position to its active position in response to the input force and activating one of such at least two circuits which may couple with the one of such at least two of the sections, thereby generating the electric signal which represents one of the characters assigned to the one of such at least two of the sections.

In another exemplary embodiment of the seventeenth aspect of this invention, a method may include the steps of defining multiple exposed sections in or on the key; disposing at least two of the sections in different areas of the key; assigning at least two of the sections with different characters; providing at least two signal units capable of generating an electric signal in response to input force applied thereto by an user; coupling each of such at least two units to only one of such at least two of the sections; and receiving the input force from an user by one of such at least two of the sections and activating one of such at least two circuits which may be coupled to the one of such at least two of the sections, thereby generating the electric signal representing one of the characters assigned to the one of such at least two of the sections.

Various embodiments of such sixteenth and seventh aspects of this invention may include the features which have been described in conjunction with the above fourteenth and fifteenth aspects of the present invention and may also include one or more of the following features.

The method may include the step of applying the input forces to the sections assigned with the characters consecutively without additional manipulation of another key, thereby allowing the user to select different characters assigned (or associated) therewith. Alternatively, the method may include the step of applying the input forces to those sections assigned with such characters consecutively, thereby allowing the user to select the characters assigned to such sections consecutively, without cooperation of another key. The method may include the steps of disposing the foregoing recoil units, circuits, and/or signal units under or around the sections and generating different electric signals each representing one of such different characters.

In the eighteenth aspect of the present invention, various methods may further be provided for selecting multiple characters by a multi-part key.

In one exemplary embodiment of the eighteenth aspect of this invention, a method may include the steps of defining on the key multiple parts capable of moving with respect to each other; assigning each of at least two of the parts with a different character; and then selecting each of the characters which is assigned to each of such at least two of the parts by applying input force only to the one of such at least two of the parts but not to the other thereof, without requiring an user to apply another input force to another key.

In another exemplary embodiment of the eighteenth aspect of the present invention, a method may include the steps of defining over the key multiple parts capable of moving with respect to each other, assigning each of at least two of the parts with a different character, providing such each of such at least two of the parts with different physical properties on their surfaces, thereby providing an user with different sensations; allowing an user to identify such each of at least two of the parts by the sensations; and selecting each of the characters which is arranged to be assigned to each of such at least two of the parts by applying input force only to the one of such at least two of the parts but not to the other thereof without requiring an user to apply another input force to another key.

In another exemplary embodiment of the eighteenth aspect of the present invention, a method may include the steps of defining over the key multiple parts capable of moving with respect to each other; assigning each of at least two of the parts with a different character; arranging such each of such at least two of the parts to have a different orientation relative to each other; allowing an user to identify such each of at least two of the parts by the orientation; and selecting each of the characters which is assigned to each of such at least two of the parts by applying input force only to the one of such at least two of the parts but not to the other thereof, without requiring an user to apply another input force to another key.

In another exemplary embodiment of the eighteenth aspect of the present invention, a method may include the steps of defining over the key multiple parts capable of moving with respect to each other; assigning each of at least two of the parts with a different character; arranging such each of at least two of the parts to generate movement of the key in a different path in response to a different input force applied by an user; and selecting each of the characters which may be assigned to each of such at least two of the parts by applying input force only to such one of such at least two of the parts but not to the other thereof and by moving the each of such at least two of the parts along the different path without requiring an user to apply another input force to another key.

In the nineteenth aspect of the present invention, various methods may further be provided for selecting multiple characters including numerals, alphabets, and symbols by a key with multiple mobile parts.

In one exemplary embodiment of the eighteenth aspect of this invention, a method may include the steps of defining on the key multiple parts capable of moving with respect to each other; assigning one of such at least two of the parts with a single numeral; assigning the other of such at least two of the parts with a single alphabet; and arranging each of the parts to receive input force applied by an user only to a portion thereof and to not respond to another input force applied to the other of such parts, thereby enabling an user to select each of the numeral and alphabet which is assigned to such each of the parts but not to the other thereof.

In another exemplary embodiment of the nineteenth aspect of the present invention, a method may include the steps of defining on the key multiple parts which are capable of moving with respect to each other; assigning one of such at least three of the parts with a single numeral; assigning one of the rest of such at least three of the parts with a single alphabet; and arranging each of such parts to receive input force applied by an user only to its portion and to not respond to input force applied to the other of such parts, thereby enabling an user to select each of the numeral and alphabet which is assigned to the each of the parts but not to the other thereof.

In another exemplary embodiment of the nineteenth aspect of the present invention, a method may include the steps of defining on the key multiple parts which are capable of moving with respect to each other; assigning one of such at least four of the parts with a single numeral; assigning one of the rest of such at least four of the parts with a single alphabet; and arranging each of such parts to receive input force applied by an user only to its portion and to not respond to input force applied to the other of such parts, thereby enabling an user to select each of the numeral and alphabet which is assigned to the each of the parts but not to the other thereof.

In another exemplary embodiment of the nineteenth aspect of the present invention, a method may include the steps of defining on the key multiple parts which are capable of moving with respect to each other; assigning one of such at least five of the parts with a single numeral; assigning one of the rest of such at least five of the parts with a single alphabet; and arranging each of such parts to receive input force applied by an user only to its portion and to not respond to input force applied to the other of such parts, thereby enabling an user to select each of the numeral and alphabet which is assigned to the each of the parts but not to the other thereof.

Various embodiments of the above eighteenth and nineteenth aspects of the present invention may also include one or more of the following features.

The defining step may include the step of defining two, three, four, five or six of the parts over or on the key. The defining step may include the steps of disposing at least two of the parts in or over different areas of the key and independently applying the input forces to such different areas.

The assigning step may include the steps of assigning one of such parts with a single numeral and assigning each of the rest of the parts with a single alphabet and/or symbol. The assigning step may include the steps of assigning one of such parts with a single symbol and assigning each of the rest of the parts with a single alphabet and/or different symbol.

The method may further include the step of providing at least two of the parts with different properties which may include at least one of elevations, inclinations or angles, textures, shapes such as numbers of sides and/or vertices, sizes, orientations, exposed areas, contours, colors, and so on. The defining step may include the step of arranging each of the at least two of the parts to move with respect to the other thereof. The defining step may include the step of disposing the parts of the key closer to each other than other parts of another key. The defining step may alternatively include the step of enclosing the parts of the key within a housing or another step of disposing such parts of the key within a finger's grasp. The defining step may include the step of arranging opposing surfaces of the parts to match each other to allow individual movements thereof.

The moving step may include one or more of the steps of vertically moving the part and/or key, horizontally moving such, angularly moving such, and so on. The moving step may have one or more of the steps such as translating such a part and/or key in a curvilinear path, rotating or pivoting such therealong, reciprocating such therealong, and the like. The moving step may also include the step of moving at least two of such parts along different paths and/or in different directions. The moving step may also include the step of moving one of such parts between its rest position and its active position, where such one of the parts may be disposed in the rest position when the input force is not applied thereto and moved to the active position in response to the input force.

The method may include the step of providing at least one recoil unit arranged to return one of the parts to its rest position from its active position after the input force is applied. The arranging step may include the step of applying the input forces to the parts which are assigned with the characters consecutively without additional manipulation of the other key, thereby allowing such an user to select different characters assigned (or associated) therewith. The arranging may further include the step of applying the input forces to the parts assigned with the characters consecutively, thereby allowing the user to select the characters assigned to the parts consecutively without cooperation of another key. The method may include the steps of providing multiple circuits each of which may be capable of generating a different electric signal in response to the input force and may operatively couple each of the parts with at least one of the circuits.

In the twentieth aspect of the present invention, various methods may be provided to select multiple different characters using a multi-part key unit including a key.

In one exemplary embodiment of the twentieth aspect of this invention, a method may include the steps of providing multiple parts of the key within a preset distance; disposing at least two of such parts in different areas of the key; assigning at least two of such parts with different characters; and moving each of such at least two of such parts from its rest position to its active position by applying different input force to each of such at least two of the parts, thereby selecting one of the characters by applying the input force to only one of such at least two of the parts and not to the other thereof.

In another exemplary embodiment of the twentieth aspect of this invention, a method may have the steps of providing multiple parts to the key within a preset distance; arranging at least two of such parts to move from their rest positions to active positions in response to input force applied thereto by an user; disposing such at least two of the parts in different areas of the key; assigning such at least two of the parts with different characters; providing at least two recoil units each of which may be arranged to be coupled to only one of such at least two of the parts; arranging each of such at least two recoil units to store at least a portion of energy associated with the input force and to release the portion of the energy to return only one of such at least two of the parts from its active position to its rest position upon cessation of application of the input force; moving each of such at least two of the parts by applying the input force to each of such at least two of the parts and not to the other thereof and then returning each of such at least two of the parts to its rest position by each of such at least two recoil units, thereby enabling the user to select each of the different characters by manipulating the each of the at least two of the parts.

In the twenty-first aspect of the present invention, various methods may also be provided for generating electric signals for multiple characters using a multi-part key unit including a key.

In one exemplary embodiment of the twenty-first aspect of this invention, such a method may include the steps of providing the key with multiple parts within a preset distance; disposing such at least two of the parts in different areas of the key; assigning different characters to such at least two of the parts; providing at least two circuits each of which may be arranged to couple with only one of such at least two of the parts and to be activated in response to input force; and moving one of such at least two of the parts by applying the input force thereto but not to the other of such at least two of the parts, thereby enabling the user to select one of the characters by manipulating each of such at least two of the parts and generating the electric signal which represents such one of the characters by such one of the circuits coupling with such one of such at least two of the parts.

In another exemplary embodiment of the twentieth aspect of this invention, such a method may include the steps of providing multiple parts to such a key within a preset distance; disposing such at least two of the parts in different areas of the key; assigning different characters to such at least two of the parts; providing at least two signal units each of which is arranged to be coupled to only one of such at least two of the parts and to generate an electric signal responsive to input force; and moving one of such at least two of the parts by applying the input force thereto but not to the other thereof, thereby enabling the user to select one of the characters by manipulating such each of such at least two of the parts and generating the electric signal representing such one of the characters by such one of the signal units coupling with such one of such at least two of the parts.

Various embodiments of such twentieth and twenty-first aspects of this invention may include the features which have been described in conjunction with the foregoing eighteenth and nineteenth aspects of the present invention and may also include one or more of the following features.

The providing step may include the step of defining two, three, four, five or six of the parts on or over the key. The providing step may include the step of disposing at least two of the parts on or over different areas of the key and independently applying the input forces to such different areas of the key.

The providing step may have the step of arranging each of such at least two of such parts to move with respect to the other thereof. The providing step may have the step of disposing such parts of the key closer to each other than other parts of another key. The providing step may also have the step of enclosing the parts of the key within a housing. The providing step may also include the step of disposing such parts of the key within a finger's grasp. The providing step may include the step of arranging opposing surfaces of the parts to match each other to allow individual movements thereof.

The moving step may include the step of applying the input forces to such parts assigned with the characters consecutively without additional manipulation of other keys, thereby allowing the user to select different characters assigned (or associated) therewith. The moving may instead include the step of applying the input forces to the parts assigned with the characters consecutively, thereby allowing the user to select the characters assigned to the parts consecutively without cooperation of another key. The providing step may also include the step of disposing at least one recoil unit, circuit, and/or signal unit under or around the at least two of the sections.

In the twenty-second aspect of the present invention, various methods may also be provided for expressing multiple characters by a key assembly.

In one aspect of the twenty-second aspect of the present invention, such a method may have the steps of arranging multiple keys in preset numbers of rows and/or columns; providing at least two exposed sections (or parts) over different areas of each of the at least two of the keys; assigning a different character to each of the at least two sections (or parts); and applying input force only to one of such at least two sections (or parts) but not to the other thereof when an user selects one of such characters assigned to such one of such at least two sections (or parts).

In another aspect of the twenty-second aspect of the present invention, a method may include the steps of arranging multiple keys in preset numbers of rows and/or columns; providing at least two exposed sections (or parts) on different areas of each of the at least two of the keys; arranging such at least two sections (or parts) to have different properties on their surfaces to provide an user with different sensations; assigning a different character to each of such at least two sections (or parts); identifying such at least two sections (or parts) by such sensations; and applying input force only to one of such at least two sections (or parts) but not to the other thereof when selecting one of such characters assigned to such one of such at least two sections (or parts).

In another aspect of the twenty-second aspect of the present invention, a method may include the steps of arranging multiple keys in preset numbers of rows and/or columns; providing at least two exposed sections (or parts) over different areas of each of such at least two of the keys; arranging such at least two sections (or parts) to have different orientations along different angles to provide an user with different sensations; assigning a different character to each of such at least two sections (or parts); identifying such at least two sections (or parts) by the sensations; and applying input force only to one of such at least two sections (or parts) but not to the other thereof when selecting one of the characters assigned to such one of such at least two sections (or parts).

In another aspect of the twenty-second aspect of the present invention, a method may include the steps of arranging multiple keys in preset numbers of rows and/or columns; providing at least two exposed sections (or parts) over different areas of each of the at least two of the keys; assigning a different character to each of such at least two sections (or parts); and providing input force only to one of such at least two sections (or parts) but not to the other thereof and moving the key along one of multiple directions when selecting one of the characters assigned to such one of such at least two sections (or parts).

In the twenty-third aspect of the present invention, various methods may also be provided for expressing multiple characters by a key assembly.

In one aspect of the twenty-third aspect of the present invention, such a method may include the steps of arranging multiple keys in preset numbers of rows and/or columns; providing at least two exposed sections (or parts) on or over different areas of each of at least two of the keys; assigning a different character to each of such at least two sections (or parts); providing at least two recoil units capable of storing at least a portion of energy of input force and releasing such a portion of the energy; coupling each of the recoil units to each one of such at least two of the sections (or parts); providing input force only to one of such at least two sections (or parts) but not to the other thereof while storing the portion of the energy by one of such at least two recoil units coupling with such one of such at least two sections (or parts) when selecting one of the characters assigned to such one of such at least two sections (or parts); and releasing the portion of the energy to return such one of such at least two of the sections (or parts) to its original position.

In another aspect of the twenty-third aspect of this invention, a method may include the steps of arranging multiple keys in preset numbers of rows and/or columns; providing at least two exposed sections (or parts) over or on different areas of each of at least two of the keys; assigning a different character to each of such at least two sections (or parts); providing at least two circuits (or signal units) each capable of generating an electric signal in response to input force applied thereto by an user; operatively coupling each of such circuits (or signal units) with each one of such at least two of the sections (or parts); and providing input force only to one of such at least two sections (or parts) but not to the other thereof while generating the electrical signal by one of the circuits (or signal units) coupling with such one of such at least two sections (or parts) when selecting one of the characters assigned to such one of such at least two sections (or parts).

In the twenty-fourth aspect of the present invention, various methods may further be provided for representing multiple characters such as numerals, alphabets, and symbols by a key assembly.

In one aspect of the twenty-fourth aspect of the present invention, a method may include the steps of providing multiple keys of which the number may be less than a number of such characters; arranging such a plurality of keys in preset numbers of rows and/or columns; providing at least two exposed sections (or parts) over or on different areas of each of at least two of the keys; grouping the numerals into a first plurality of sets; assigning the first plurality of sets to one of the first plurality of the sections (or parts); grouping at least one of the alphabets and/or symbols to a second plurality of sets; assigning each of the second plurality of sets to one of the second plurality of the sections (or parts); and then consecutively applying different input forces to one of each of such at least two sections (or parts) but not to the other thereof, thereby representing each of the characters assigned to such at least two sections (or parts) of one of the keys without manipulating any other of the keys.

In another aspect of the twenty-fourth aspect of the present invention, a method may include the steps of arranging multiple keys into positions of elements of a four-by-three matrix; providing at least two exposed sections (or parts) over or on different areas of each of at least two of the keys; assigning each of the numerals to one of the sections (or parts) of each of a first number of the keys; assigning each of one of the alphabets and the symbols to one of the sections (or parts) of each of a second number of the keys; and then consecutively applying different input forces to one of each of such at least two sections (or parts) but not to the other thereof, thereby representing each of such characters assigned to such at least two sections (or parts) of one of the keys without manipulating any other of the keys.

In the twenty-fifth aspect of the present invention, various methods may also be provided for representing multiple characters including multiple numerals from 0 to 9 and multiple alphabets from A to Z by a key assembly.

In one aspect of the twenty-fifth aspect of the present invention, such a method may have the steps of arranging multiple keys into positions of elements of a four-by-three matrix; providing at least two exposed sections (or parts) over different areas of each of the keys; grouping the numerals into a first group of 1 through 3, a second group of 4 through 6, a third group of 7 through 9, and a fourth group of 0; sequentially assigning each of the first, second, third, and fourth groups of the numerals into the sections (or parts) of a first, second, third, and fourth row of the keys, respectively; grouping the alphabets into a first group of A through F, a second group of G through O, and a third group of P through Z; sequentially assigning each of the first, second, and third groups of the alphabets into the sections (or parts) of a first, second, and third row of the keys, respectively; and then consecutively applying different input forces to one of each of such at least two sections (or parts) but not to the other thereof, thereby representing each of the characters assigned to such at least two sections (or parts) of one of the keys without manipulating any other of the keys.

In another aspect of the twenty-fifth aspect of the present invention, a method may include the steps of arranging multiple keys into positions of elements of a four-by-three matrix; providing at least two exposed sections (or parts) over different areas of each of the keys; grouping the numerals into a first group of 1 through 3, a second group of 4 through 6, a third group of 7 through 9, and a fourth group of 0; sequentially assigning each of the first, second, third, and fourth groups of the numerals into the sections (or parts) of a first, second, third, and fourth row of the keys, respectively; grouping the alphabets into a first group of A to G, a second group of H to P, a third group of Q to V, and then a fourth group of W to Z; sequentially assigning each of the first, second, third, and fourth groups of the alphabets to the sections (or parts) of a first, second, third, and fourth row of the keys, respectively; and then consecutively providing different input forces to one of each of such at least two sections (or parts) but not to the other thereof, thereby representing each of the characters assigned to such at least two sections (or parts) of one of the keys without manipulating any other of the keys.

In another aspect of the twenty-fifth aspect of the present invention, a method may include the steps of arranging multiple keys into positions of elements of a four-by-three matrix; providing at least two exposed sections (or parts) over different areas of each of the keys; grouping the numerals into a first group of 1 through 3, a second group of 4 through 6, a third group of 7 through 9, and a fourth group of 0; sequentially assigning each of the first, second, third, and fourth groups of such numerals into the sections (or parts) of a first, second, third, and fourth row of the keys, respectively; grouping the alphabets into a first group of A to G, a second group of H to N, a third group of O to U, and then a fourth group of V to Z; sequentially assigning each of the first, second, third, and fourth groups of the alphabets to the sections (or parts) of a first, second, third, and fourth row of the keys, respectively; and then consecutively applying different input forces to one of each of such at least two sections (or parts) but not to the other thereof, thereby representing each of the characters assigned to such at least two sections (or parts) of one of the keys without manipulating any other of the keys.

In another aspect of the twenty-fifth aspect of the present invention, a method may include the steps of arranging multiple keys into positions of elements of a four-by-three matrix; providing at least two exposed sections (or parts) over different areas of each of the keys; grouping the numerals into a first group of 1 through 3, a second group of 4 through 6, a third group of 7 through 9, and a fourth group of 0; sequentially assigning each of the first, second, third, and fourth groups of such numerals into the sections (or parts) of a first, second, third, and fourth row of the keys, respectively; grouping the alphabets into a first group of Q, W, E, R, T, Y, U, I, and O, a second group of A, S, D, F, G, H, J, K, and L, and a third group of Z, X, C, V, B, N, and M; sequentially assigning each of such first, second, and third groups of such alphabets into the sections (or parts) of a first, second, and third row of the keys, respectively; and then consecutively providing different input forces to one of each of such at least two sections (or parts) but not to the other thereof, thereby representing each of the characters assigned to such at least two sections (or parts) of one of the keys without manipulating any other of the keys.

In another aspect of the twenty-fifth aspect of the present invention, a method may include the steps of arranging multiple keys into positions of elements of a four-by-three matrix; providing at least two exposed sections (or parts) over different areas of each of the keys; grouping the numerals into a first group of 9, 8, and 7, a second group of 6, 5, and 4, a third group of 3, 2, and 1, and a fourth group of 0; sequentially assigning each of the first, second, third, and fourth groups of the numerals into the sections (or parts) of a first, second, third, and fourth row of the keys, respectively; grouping the alphabets into a first group of Q, W, E, R, T, Y, U, I, and O, a second group of A, S, D, F, G, H, J, K, and L, and a third group of Z, X, C, V, B, N, and M; sequentially assigning each of such first, second, and third groups of the alphabets into the sections (or parts) of a first, second, and third row of such keys, respectively; and then consecutively applying different input forces to one of each of such at least two sections (or parts) but not to the other thereof, thereby representing each of the characters assigned to the at least two sections (or parts) of one of the keys without manipulating any other of the keys.

Various embodiments of such twenty-second to twenty-fifth aspects of the present invention may also include the features which have been described in conjunction with the above fourteenth to twenty-first aspects of the present invention.

In another aspect of the present invention, various processes may also be provided for such keys, key units, and/or key assemblies as described heretofore and/or hereinafter. More particularly, claims for such processes may be readily constructed by using various preambles of such foregoing apparatus claims and by employing various bodies of such foregoing method claims.

As used herein, “characters” may collectively refer to a variety of numerals, alphabets, and/or symbols. In general, “numerals (or numbers)” may refer to the Arabic numerals, the Roman numerals, and other numerals in use which may or may not be based on 10. In general, “alphabets” may refer to consonants and vowels of various languages, including both of upper and lower cases thereof. For example, a total number of the “alphabets” of English language amount to 52, including 26 upper cases and 26 lower cases thereof. In addition, “alphanumerals” may collectively refer to various alphabets and numerals. Adopting such a term, the “characters” may collectively refer to various alphanumerals and/or symbols. “Symbols” generally refer to all other characters of which the examples may include, but not be limited to: (1) text symbols (e.g., a comma [,], a period [.], a question mark [?], an ampersand [&], a slash [/], an exclamation mark [!], a star [*], a sharp or a number [#], and the like.); (2) arithmetic symbols (e.g., an addition [+], a subtraction [−], a division [/], a multiplication [×], an equality [=], and the like]; (3) mathematical symbols (e.g., a natural exponent [e], other numeric and alphabetic exponents, and the like); (4) the Greek symbols; and (5) other symbols available in various fonts of conventional word processing software. As used herein, the above “numerals,” “alphabets,” and “symbols” may typically be defined to be mutually exclusive so that “numerals” may not include any “alphabets” and/or “symbols,” that “alphabets” may not include any “numerals” and/or “symbols,” that “symbols” may not include any “numerals” and/or “alphabets,” and that each category of the “symbols” may not include others of different categories thereof. Several exceptions, however, may exist against the foregoing definition, examples of which may include, but not limited to, commonly used characters such as “−” (a hyphen as a text symbol or a subtraction as an arithmetic symbol), “×” (an alphabet or a multiplication as an arithmetic symbol), “/” (a slash as a text symbol or a division as an arithmetic symbol), and the like.

A term “key” may refer to any mobile or stationary object which may be capable of receiving input force applied thereto by an user. Such a “key” may have any arbitrary shapes and/or sizes as long as an user may easily apply input forces thereto. A “key unit” may refer to an electromechanical, optomechanical, and/or magnetomechanical assembly capable of generating electrical, optical, and/or magnetic signals in response to user inputs applied to the key of the key assembly. Such a “key unit” generally includes a single key to which various electrical, mechanical, and/or magnetic units may be coupled. A term “key assembly” generally refers to a collection of keys which may be arranged in a matrix of multiple rows and columns, in a staggering arrangement of multiple rows and columns, in an array with arbitrary numbers of rows and columns and/or with arbitrary arrangement patterns of the rows and columns, and so on. The “key assembly” may also represent a collection of such key units which may be similarly arranged as the keys as described hereinabove.

A “section” of a key (or a key unit) may refer to a segment, a portion or a region thereof which may be exposed to an user and receive input force applied thereto by the user. In general, a key (or a key unit) may define a single or multiple sections thereon, where each section may be arranged to be contiguous (or continuous) with a body of the key. Each section may be generally unitary with a body of the key, fixated to such a body, fixedly attached and/or glued to such a body, fixedly assembled or otherwise fixedly coupled to such a body so that each section may be arranged to move and/or to be positioned together (or in unison) with the key. Each section may generally be arranged to occupy a certain area on the body of the key and may be disposed on a surface, an edge, a corner, a top or a side of the body of the key. Each section or some sections may be arranged to have distinguishable (or distinct) boundaries because of their configurations such as, e.g., contours, surfaces, directions, angles, elevations, sizes, shapes, colors, textures, and the like. Each section or some sections may also be arranged to define their own areas but to not have distinguishable boundaries, although each or some of such boundaries may be assigned with at least one number and/or alphabets.

Similar to the foregoing “section,” a “part” of a key (or a key unit) may represent an individual component of the key (or a key unit) also arranged to receive the input force from the user. Contrary to the foregoing “section,” however, the “part” of a key may move with respect to the rest of the key or, in other words, such a “part” may refer to a “mobile part” in contrary to the “stationary section” of the key. Each key may include a single part or multiple parts, where each “part” may be arranged to not be contiguous (or continuous) with the rest of the key. Accordingly, each “part” may generally be physically apart from each other and may individually move (or be displaced) in response to the input force. When desirable, some but not all of such “parts” of a single key may be coupled to each other and move in unison in response to the input force with respect to the rest of such “parts” of the same key.

A phrase “assigning a numeral (or alphabet) to a section (or part) of a key” represents that the numeral (or alphabet) may be physically imprinted on (or around) the section (or part) of the key, that the numeral (or alphabet) may be temporarily and optically displayed on (or around) such a section (or part) of the key, that the key may be arranged to express or represent the numeral (or alphabet), that the key may be an operative portion of a key assembly which may be arranged to generate electrical and/or optical signals which may represent or correspond to the numeral (or alphabet), and the like.

A phrase “within a finger's grasp” refers to an arrangement of multiple sections (or parts) of a key with which an user may select and manipulate (e.g., by pressing, clicking, double clicking, tilting, rotating, swiveling, touching, and the like) each section (or part) of a single key with his or her finger without having to lift the same finger from the rest of the sections (or parts) of the same key. Such a phrase may also include an arrangement where the user may need to translate the same finger by a minimal distance but still contact the rest of the sections (or parts) of the key during such manipulation. Multiple sections (or parts) of a key which may be disposed “in proximity” or “within a preset distance from each other” may be synonymous with the sections (or parts) disposed “within a finger's grasp.”

Unless otherwise defined in this specification, all technical and/or scientific terms used herein carry the same meaning as commonly understood or used by one of ordinary skill in the art to which this invention belongs. Although various methods and/or materials that are equivalent to or similar to those described herein can be used in practice or testing of the present invention, suitable methods and/or materials are described herein. All published patent applications, patents, publications, and other references mentioned herein are incorporated by reference in their entirety. In case of conflict, the present specification, including definitions, will control. Furthermore, unless otherwise specified, the materials, methods, and/or examples herein are exemplary and illustrative only, and not intended to be limiting the scope of this invention.

### BRIEF DESCRIPTION OF THE DRAWINGS

FIG. 1A is a schematic diagram of an exemplary key which defines a center section and four side sections therearound according to the present invention;

FIG. 1B is a schematic diagram of another exemplary key similar to that of FIG. 1A but having a center section raised over four side sections according to the present invention;

FIG. 1C is a schematic diagram of another exemplary key similar to that of FIG. 1A but having a center section buried below four side sections according to the present invention;

FIG. 1D is a schematic diagram of another exemplary key which defines a center section and three side sections therearound according to the present invention;

FIG. 1E is a schematic diagram of another exemplary key similar to that of FIG. 1D but having a center section raised over three side sections according to the present invention;

FIG. 1F is a schematic diagram of another exemplary key similar to that of FIG. 1D but having a center section buried below three side sections according to the present invention;

FIG. 2A is a schematic diagram of another exemplary key which defines a center part and four side parts therearound according to the present invention;

FIG. 2B is a schematic diagram of another exemplary key similar to that of FIG. 2A but having a center part raised over four side parts according to the present invention;

FIG. 2C is a schematic diagram of another exemplary key similar to that of FIG. 2A but having a center part buried below four side parts according to the present invention;

FIG. 2D is a schematic diagram of another exemplary key defining a center part and three side parts therearound according to the present invention;

FIG. 2E is a schematic diagram of another exemplary key similar to that of FIG. 2D but having a center part raised over three side parts according to the present invention;

FIG. 2F is a schematic diagram of another exemplary key similar to that of FIG. 2D but having a center part buried below three side parts according to the present invention;

FIG. 3A is top views of exemplary keys defining four sections or parts similar to those of FIGS. 1D to 1F and 2D to 2F according to the present invention;

FIG. 3B is top views of further exemplary keys defining four sections or parts similar to those of FIGS. 1D to 1F and 2D to 2F according to the present invention;

FIG. 3C is top views of further exemplary keys defining four sections or parts similar to those of FIGS. 1D to 1F and 2D to 2F according to the present invention;

FIG. 3D is top views of further exemplary keys defining four sections or parts similar to those of FIGS. 1D to 1F and 2D to 2F according to the present invention;

FIG. 3E is top views of further exemplary keys defining four sections or parts similar to those of FIGS. 1D to 1F and 2D to 2F according to the present invention;

FIG. 4A is top views of exemplary keys defining five sections or parts similar to those of FIGS. 1A to 1C and 2A to 2C according to the present invention;

FIG. 4B is top views of further exemplary keys defining five sections or parts similar to those of FIGS. 1A to 1C and 2A to 2C according to the present invention;

FIG. 5A is top views of keys defining four sections or parts which are assigned according to an exemplary arrangement of characters according to the present invention;

FIG. 5B is top views of keys defining four sections or parts which are assigned according to another exemplary arrangement of characters according to the present invention;

FIG. 5C is top views of keys defining four sections or parts which are assigned according to yet another exemplary arrangement of characters according to the present invention;

FIG. 5D is top views of keys defining four sections or parts which are assigned according to yet another exemplary arrangement of characters according to the present invention;

FIG. 6A is top views of keys defining five sections or parts which are assigned according to an exemplary arrangement of characters according to the present invention; and

FIG. 6B is top views of keys defining five sections or parts which are assigned according to another exemplary arrangement of characters according to the present invention.

### DETAILED DESCRIPTION OF EXEMPLARY EMBODIMENTS

The present invention generally relates to exemplary aspects and their embodiments of various keys, various key units incorporating such keys, and various key assemblies incorporating such keys and/or key units. More particularly, such a key of the present invention may preferably include multiple sections (or parts) each of which may be assigned or associated with a different character such as a numeral, an alphabet, and/or a symbol. The key unit of the present invention may include mechanical and/or electrical units each of which may be coupled to one of such sections (or parts) of the key and to allow the user to represent such a character assigned to one of such sections (or parts) simply by applying input force thereto. Therefore, such a key unit of the present invention may advantageously allow the user to select any of multiple characters assigned to different sections (or parts) of a single key by providing single input force to any of such sections (or parts), without having to require such an user to manipulate another section of another key. Moreover, such a key unit of this invention may advantageously allow the user to consecutively select all of multiple characters assigned to different sections (or parts) of the single key by consecutively applying input forces only to different sections (or parts) of such a key, without requiring the user to manipulate another section (or part) of another key during manipulation of such sections (or parts) of such a single key and/or without necessitating the user to wait for a preset period to select one of multiple characters assigned to such a single key. The key assembly of the present invention may incorporate such keys and/or key units of the present invention arranged according to preset patterns for the purpose of allowing the user to select each of the character assigned to various sections (or parts) of each of the keys by applying the input forces only to desired sections (or parts) but not to other auxiliary keys thereof.

Various keys, key units, and/or key assemblies of the present invention may be used in almost any keyboards and/or keypads for almost any languages. For example, such keys, key units, and key assemblies may be incorporated into keyboards of desktop computers, laptop computers, computers for laboratories, factories, industries, and so on. Such keys, key units, and key assemblies may also be incorporated into keypads for telephones, mobile phones, PDA's, organizers, and the like. Various exemplary aspects and/or embodiments of various keys, key units, and/or key assemblies will now be described.

Various keys, key units, and/or key assemblies of the present invention may readily be applied to those which may involve depression and recoiling of such keys for selecting characters assigned thereto. The keys, key units, and/or key assemblies of the present invention may also be incorporated into conventional electric or electromechanical keys, key units, and/or key assemblies which may only involve touching of at least portions thereof to select such characters. Such keys, key units, and/or key assemblies of the present invention may also be incorporated into keypads for selecting numerals, alphabets, and symbols. Such keys, key units, and/or key assemblies may further be incorporated to keypads for selecting various functions rather than specific numerals, alphabets or symbols, where examples of devices having such keypads may include, but not be limited to, calculators, organizers, control panels, and the like.

Various exemplary aspects and/or embodiments of keys, key units, and/or key assemblies and methods therefor of the present invention will now be described with reference to the accompanying drawings and text, where such aspects and/or embodiments may only represent different forms. The keys, key units, and/or key assemblies and methods therefor of the present invention, however, may also be embodied in many other different forms and, therefore, should not be limited to such aspects and/or embodiments set forth herein. Rather, various exemplary aspects and/or embodiments of such keys, key units, and key assemblies and their methods therefor described herein are provided so that the following disclosure will be thorough and complete and will fully convey the scope of the present invention to one skilled in the relevant art.

It is to be understood, unless otherwise specified, that various members, elements, and units of the keys, key units, and key assemblies are not generally drawn to scales or proportions for ease of illustration. It is also understood that the members, elements, and units of the keys, key units, and key assemblies designated by the same or similar numerals may generally represent the same, similar, and/or functionally equivalent members, elements, and units thereof, respectively.

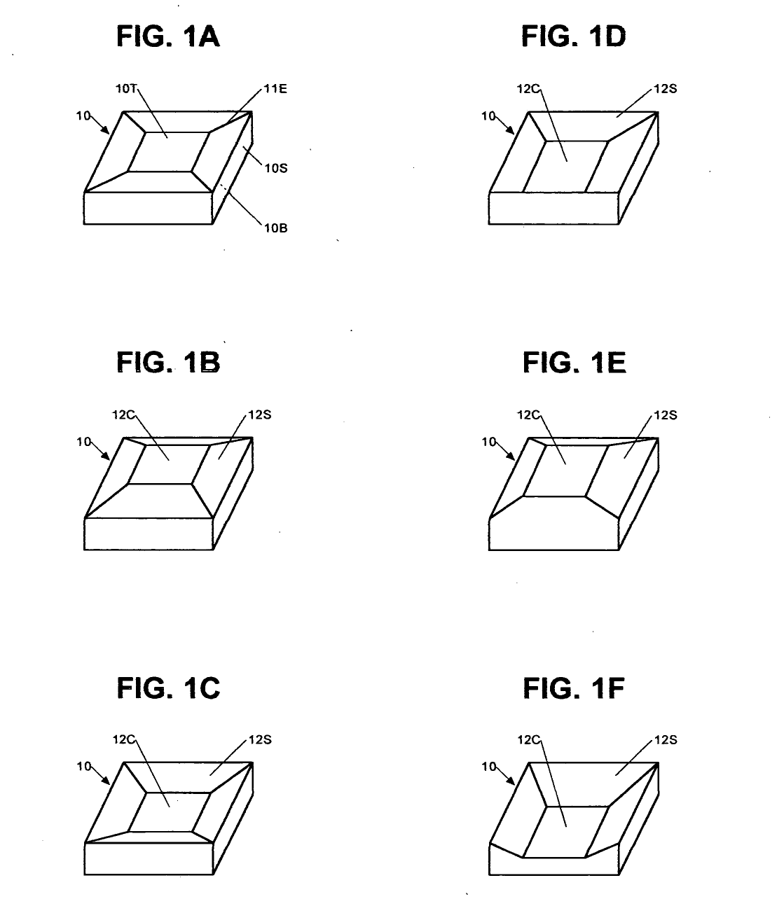

In one aspect of the present invention, various keys may be arranged to form multiple sections thereon and to be assigned with different characters to each or at least a substantial number of such sections. In general, such keys are arranged to include unitary bodies on different areas of which the sections are defined. Accordingly, any input force applied to any of such sections of such a key may generally move an entire portion of the key along a preset direction which may be determined by, e.g., a direction of the input force, mechanical arrangements of the key, and the like. Following FIGS. 1A to 1F describe several exemplary embodiments of such an aspect of the present invention, where each exemplary key may define a top 10T, a bottom 10B, and multiple sides 10S and where center sections 12C and side sections 12S are formed on or over different surfaces, areas, and/or portions of the top 10T and sides 10S of the key 10.

FIG. 1A is a schematic diagram of an exemplary key which defines a center section and four side sections therearound according to the present invention. An exemplary key 10 has a shape of a cube and defines a single center section 12C on its top 10T and four side sections 12S around such a center section 12C. The center section 12C is disposed in a center of the top 10T of the key 10 and has a square or rectangular shape, while each of the side sections 12S extends outwardly from one edge of the center section 12C to the corresponding side 12S. Such sections 12C, 12S are typically separated from one another by multiple edges 11E in order to aid an user to physically identify one of such sections from the rest thereof. It is to be understood that such a key 10 is generally made as an unitary article and that the unitary key 10 may be arranged to move in different directions in response to input forces applied by the user onto different sections 12C, 12S of the key 10. In addition, each of such sections 12C, 12S may be assigned with a different character such that the user may apply only single input force to a specific section 12C, 12S of the key in order to select such a character which may be assigned to such a section 12C, 12S. Details of various movements of the unitary key 10 in response to the input forces and details of character arrangements will be described in greater detail below.

In operation, each of the sections 12C, 12S of the key 10 is assigned with one character such as, e.g., a numeral, an alphabet, and/or a symbol. As the user intends to represent such a character, he or she first identifies a location of the section 12C, 12S assigned with such a character, and then applies the single input force to such a section 12C, 12S. In response thereto, an entire portion of the key 10 may be arranged to move from its rest position to its active position along a preset direction or along one of multiple directions which may be determined by various factors example of which may include, but not be limited to, to a direction of the input force, a location of the section 12C, 12S onto which such input force is exerted, details of mechanical characteristics of such a key 10, and so on.

In one example, the unitary multi-section key 10 may be arranged to move (e.g., translate, pivot or rotate) in a horizontal direction which may generally be parallel with the top 10T of the key 10. For example, the multi-section key 10 may move toward a front thereof, a rear thereof, a left side thereof, and a right side thereof as the input force is respectively applied to one of the side sections 12S from such rear, front, right, and left (or when the input force is respectively applied to a lower side section, an upper side section, a right side section, and a left side section). In the alternative, the key 10 may be arranged to move toward its front, rear, left, and right as the input force is applied respectively to one of such side sections 12S from its front, rear, left, and right (or as the input force is respectively applied to the upper, lower, left, and right side sections). It is to be understood that the center section 12S may be arranged to move along any of the above directions in response to the input force applied thereto. In another example, the unitary multi-section key 10 may be arranged to move along a vertical direction which may be at least partially normal and/or perpendicular to the top 10T of the key 10. For example, the multi-section key 10 may be depressed or pivoted downwardly in response to such input force, where detailed movements of the latter may be determined by a location of a center of rotation of such a key 10. More particularly, only a preset side of the key 10 may be depressed downwardly or pivoted angularly as the input force is applied to one of such sections 12C, 12S disposed in such a preset side. When the input force is applied to the center section 12C, an entire portion of the key 10 may be arranged to be depressed as well. In either example, it is to be understood that each section 12C, 12S of the multi-section key 10 may only respond to the input force which is applied thereto, but not to other input forces applied to other parts of the key 10. In other words, the unitary multi-section key 10 is location-specific such that the user may select one of multiple characters assigned to such a key by applying single input force only to one of such multiple sections 12C, 12S but not to the other thereof. Accordingly, the user does not have to activate any other key such as, e.g., a shift key or a function key, in order to select any of multiple characters which may be assigned to the single key. In addition, the user does not have to repeatedly apply the input forces to the same key in order to select one of multiple characters which may be represented by the single key in alternating modes. Thus, all such an user has to do is to identify the location of one of such sections 12C, 12S assigned with the desired character and to provide only single input force thereto, without having to press or otherwise manipulate another key and/or without having to repeatedly apply multiple input forces to the same key in selecting one character.

As will be described in greater detail below, movement of the key 10 from its rest position to its active position in response to the input force may activate a circuit or a signal unit which is operatively coupled to each section 12S, 12C of the key 10 and which is also arranged to generate an electric or optical signal representing such a character which is assigned to such a section 12S, 12C. After the desired character is represented, the user ceases to apply the input force. Then, a recoil unit which incorporates an elastic material may move such a key 10 back to its rest position, where details of the recoil units will also be described in greater detail below.

FIG. 1B is a schematic diagram of another exemplary key similar to that of FIG. 1A but having a center section raised over four side sections according to the present invention. Contrary to the key of FIG. 1A defining a flat top, a center section 12C of an exemplary key 10 of FIG. 1B may be arranged to be raised above or over surrounding side sections 12S by a preset elevation. Thus, only a portion of a top 10T of the key 10 may be flat, whereas surrounding portions of the top 10T may be slanted in a preset angle toward sides 10S. Accordingly, each of the surrounding side sections 10S may define a slanted portion which extends downwardly from one edge of the center section 12C and a vertical portion further extending downwardly to its side 10S. It is appreciated that such a center section 12C may readily be identified by the user and may easily receive the input force therefrom. Therefore, the center section 12C may be assigned with a character which may be more frequently used than other characters which may be assigned to the side sections 12S. Other configurational and/or operational characteristics of the key of FIG. 18 may be identical or similar to those of the key of FIG. 1A.

FIG. 1C is a schematic diagram of another exemplary key similar to that of FIG. 1A but having a center section buried below four side sections according to the present invention. Contrary to the key of FIG. 1A defining a flat top, a center section 12C of an exemplary key 10 of FIG. 1C may be arranged to be buried below surrounding side sections 12S by a preset depth. Thus, only a portion of a top 10T of the key 10 may be flat, whereas surrounding portions of the top 10T may be slanted along a preset angle toward sides 10S. Therefore, each of the surrounding side sections 10S may define a slanted portion extending upwardly from one edge of the center section 12C and a vertical portion extending downwardly to its side 10S. It is appreciated that such a center section 12C may readily be identified by the user and may easily receive the input force therefrom. Therefore, the center section 12C may be assigned with a character which is more frequently used than other characters assigned to other side sections 12S. Other configurational and/or operational characteristics of the key of FIG. 1C may be identical or similar to those of the key of FIGS. 1A and 1B.

FIG. 1D is a schematic diagram of another exemplary key which defines a center section and three side sections therearound according to the present invention. Similar to those of FIGS. 1A to 1C, an exemplary key 10 also has a shape of a cube and defines a single center section 12C on a top 10T thereof. However, the key 10 defines only three side sections 12S around the center section 12C so that the center section 12C may be disposed in a center of the top 10T of the key 10 and has a square or rectangular shape and that one end thereof may extend outwardly to an edge which adjoins a side of the key 10. Each of the side sections 12S extends outwardly from one edge of the center section 12C to the corresponding side 10S. Such sections 12C, 12S may also be separated from one another by multiple edges 11E in order to aid an user to physically identify one of such sections from the rest thereof. Similar to those of FIGS. 1A to 1C, such a key 10 is also generally made as an unitary article and, therefore, the unitary key 10 may be arranged to move in different directions in response to input forces applied onto different sections 12C, 12S of the key 10. In addition, each of such sections 12C, 12S may be assigned with a different character such that the user may apply only single input force to a specific section 12C, 12S of the key in order to select such a character assigned to each of such sections 12C, 12S. Details of various movements of the unitary key 10 in response to the input forces and details of character arrangements will be described in greater detail below.

FIG. 1E is a schematic diagram of another exemplary key similar to that of FIG. 1D but having a center section raised over three side sections according to the present invention. Contrary to the key of FIG. 1D defining a flat top, a center section 12C of an exemplary key 10 of FIG. 1E may be arranged to be raised above or over surrounding side sections 12S by a preset elevation. Thus, only a portion of a top 10T of the key 10 may be flat, whereas surrounding portions of the top 10T may be slanted in a preset angle toward sides 10S. It follows that the center section 12C may be deemed as a complex of the center section and one side section of FIG. 1B and that each of surrounding side sections 12S may define a slanted portion extending downwardly from one edge of such a center section 12C and a vertical portion also extending downwardly to its side 10S. In an alternative embodiment as shown in the figure, the center section 12C may extend to an edge which adjoins a side 10S of the key 10 so that the center section 12C may be bordered by a flat surface on the top 10T as well as by a vertical surface on the side 10S. It is appreciated that the center section 12C may readily be identified by the user and may easily receive the input force therefrom. Therefore, such a center section 12C may be assigned with a character which may be more frequently used than other characters which may be assigned to the side sections 12S. Other configurational and/or operational characteristics of the key of FIG. 1E may be identical or similar to those of the key of FIG. 1D.

FIG. 1F is a schematic diagram of another exemplary key similar to that of FIG. 1D but having a center section buried below three side sections according to the present invention. Contrary to such a key shown in FIG. 1D, a center section 12C of an exemplary key 10 of FIG. 1E may be buried below surrounding side sections 12S by a preset depth. Thus, only a portion of a top 10T of the key 10 may be flat, while surrounding portions of the top 10T may be slanted in a preset angle toward sides 10S. It follows that the center section 12C may be deemed as a complex of the center section and one side section of FIG. 1C and that each of surrounding side sections 10S may define a slanted portion which extends downwardly from one edge of the center section 12C and a vertical portion which extends downwardly to its side 10S. In an alternative embodiment as shown in the figure, the center section 12C may extend to an edge which adjoins a side 10S of the key 10 such that the center section 12C may be bordered by a flat surface on the top 10T as well as by a vertical surface on the side 10S. It is appreciated that such a center section 12C may readily be identified by the user and easily receive the input force therefrom. Therefore, the center section 12C may be assigned with a character which may be more frequently used than other characters which may be assigned to the side sections 12S. Other configurational and/or operational characteristics of the key of FIG. 1F may be identical or similar to those of the key shown in FIGS. 1D and 1E.

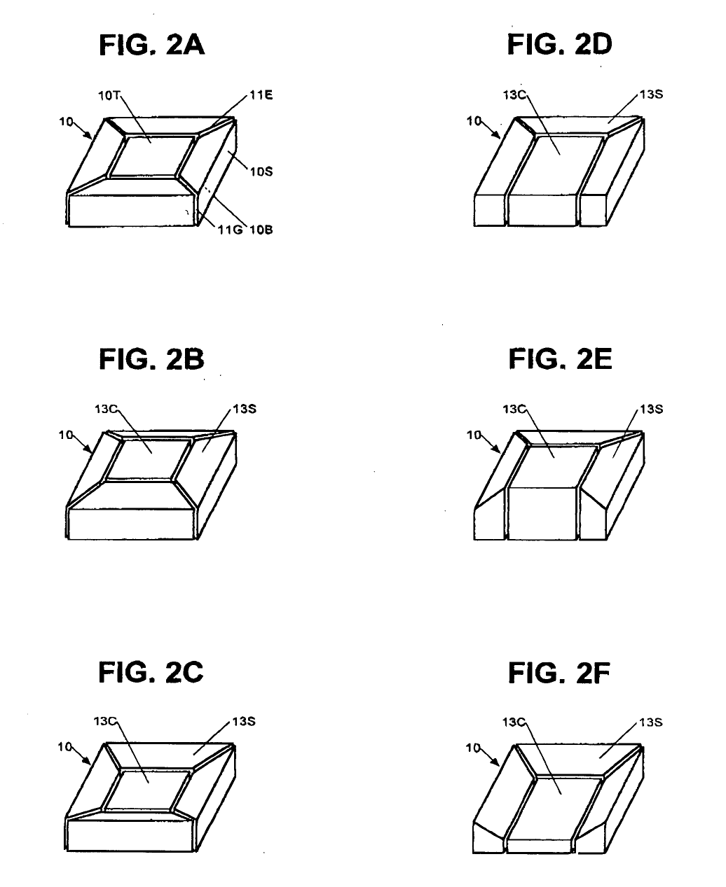

In another aspect of the present invention, various keys may be arranged to form multiple parts thereon and to be assigned with different characters to each or at least a substantial number of such parts. In general, such parts may be disposed on different areas of the key in proximity and/or within a preset distance from each other such that the user may reach each part within a finger's grasp. In addition, each or at least a substantial number of such parts may be arranged to move with respect to the rest thereof in a similar or different direction in response to input force applied thereto by the user. Accordingly, any input force applied to any of such parts of such a key may generally move only such a part in a preset direction which may be decided by, e.g., a direction of such input force, mechanical arrangements of each part and/or between such parts, and so on. Following FIGS. 2A to 2F describe several exemplary embodiments of such an aspect of the present invention, where each exemplary key may define a top 10T, a bottom 10B, and multiple sides 10S and where center parts 13C and side parts 13S are arranged in different areas or portions of the top 10T and sides 10S of the key 10.

FIG. 2A is a schematic diagram of another exemplary key which defines a center part and four side parts therearound according to the present invention. An exemplary key 10 may be deemed as a cluster and/or an aggregate of multiple parts, where such a cluster or aggregate has a cubical shape and includes a single center part 13C in its center and four side parts 13S around the center part 13C. In addition, a top of the center part 13C is exposed in a center of the top 10T of the key 10, while each of the side parts 13S may expose its top on the top 10T of the key 10 and then extend outwardly to a corresponding side 10S. Such parts 13C, 13S are generally separated from each other and define a gap 11G between neighboring parts so as to help the user physically identify one of such parts from the rest thereof and, more importantly, to allow individual movement of each of such parts between a rest position and an active position thereof independently of the rest of such parts. In the embodiment exemplified in FIG. 2A, the center part 13C may form a rod with the same square or rectangular cross-section as exposed in the top 10T of the key 10, while each of the side parts 13C, 13S may form a rod with the same trapezoidal cross-section as exposed in the top 10T thereof. Therefore, the gaps 11G formed between the center part 13C and each of the side part 13S are generally vertical and maintain an uniform distance along a vertical axis of the key 10. It is to be understood that such multiple parts of the multi-part key 10 may be arranged to move in different, similar or identical directions in response to input forces applied by the user to different parts 13C, 13S of the key 10. Each of such parts 13C, 13S may be assigned with a different character such that the user may apply only single input force to a specific part 13C, 13S of the key in order to select such a character which may be assigned to such a part 13C, 13S. Details of various movements of the multi-part key 10 in response to the input forces and details of character arrangements will be described in greater detail below.

In operation, each of the parts 13C, 13S of the key 10 is assigned with one character such as, e.g., a numeral, an alphabet, and/or a symbol. As the user intends to represent such a character, he or she first identifies a location of the part 13C, 13S assigned with such a character, and then applies the single input force to such a part 13C, 13S. In response thereto, only one part of the key 10 which receives such input force may be arranged to move from its rest position to its active position along a preset direction which may be determined by various factors examples of which may include, but not be limited to, a direction of the input force, a location of the part 13C, 13S onto which such input force is exerted, details of mechanical characteristics of such a key 10, and so on.

In one example, such parts 13C, 13S of the multi-part key 10 may be arranged to move along a horizontal direction which is generally parallel with the top 10T of the key 10. Therefore, such a part 13C, 13S may move toward a front thereof, a rear thereof, a left side thereof, and a right side thereof when the input force is respectively applied to one of the parts 13C, 13S from the front, rear, left, and right. Depending upon detailed arrangements of such movements, the moving part 13C, 13S may also be arranged to move toward other parts in response to the input force while decreasing the gaps 11G formed therebetween or, in the alternative, to move away from other parts in response thereto while increasing such gaps 11G. In another example, such parts 13C, 13S of the multi-part key 10 may be arranged to move along a vertical direction which is at least partially normal or perpendicular to the top 10T of the key 10. Therefore, such a moving part 13C, 13S may be depressed downwardly or pivot angularly in response to the input force, where detailed movements of the latter may be determined by a location of a center of rotation of such a key 10. In yet another example, such parts 13C, 13S of the key may be operatively coupled to each other such that the input force may not only allow one of the above movements of one part 13C, 13S but also render such a part 13C, 13S move the cluster and/or aggregate of such parts 13C, 13S according to one of such movements. In any of these example, it is to be understood that each part 13C, 13S of the multi-part key 10 may only respond to the input force applied thereto, but not to other input forces applied to other parts of the key 10. In other words, such a multi-part key 10 is location-specific so that the user may select one of multiple characters assigned to such a key by applying single input force only to one of such multiple parts 13C, 13S but not to the other thereof. Therefore and similar to those of FIGS. 1A to 1F, the user does not have to activate any other keys such as, e.g., a shift key or a function key, in selecting one of multiple characters which is assigned to the single key. In addition, the user does not have to repeatedly apply the input forces to the same key in order to select one of multiple characters which may be represented by the single key in alternating modes. Thus, all such an user has to do is to identify the location of one of such parts 13C, 13S which is assigned with the desired character and to provide only single input force thereto, without having to press or otherwise manipulate other keys and/or without having to repeatedly apply multiple input forces to the same key in selecting one character.

As will be described in greater detail below, movement of the key 10 from its rest position to its active position in response to the input force may activate a circuit or a signal unit which is operatively coupled to each part 13S, 13C of the key 10 and which may be also arranged to generate an electric or optical signal representing such a character which is assigned to such a part 13S, 13C. After the desired character is represented, the user ceases to apply the input force. Then, a recoil unit which incorporates an elastic material may move such a key 10 back to its rest position, where details of the recoil units will also be described in greater detail below.

FIG. 2B is a schematic diagram of another exemplary key similar to that of FIG. 2A but having a center part raised over four side parts according to the present invention. Contrary to the key of FIG. 2A with a flat top, a center part 13C of an exemplary key 10 of FIG. 2B may be arranged to be raised above or over surrounding side parts 13S by a preset elevation. Thus, only a portion of a top 10T of the key 10 may be flat, whereas surrounding portions of the top 10T may be slanted in a preset angle toward sides 10S. Therefore, each of surrounding side parts 10S may define a slanted portion which extends downwardly from one edge of the center part 13C and a vertical portion which also extends downwardly to its side 10S. It is appreciated that such a center part 13C may readily be identified by the user and may easily receive the input force therefrom. Therefore, such a center part 13C may be assigned with a character which may be more frequently used than other characters which may be assigned to the side parts 13S. Other configurational and/or operational characteristics of the key of FIG. 2B may be identical or similar to those of the key of FIG. 2A.

FIG. 2C is a schematic diagram of another exemplary key similar to that of FIG. 2A but including a center part buried below four side parts according to the present invention. Contrary to the key of FIG. 2A defining a flat top, a center part 13C of an exemplary key 10 of FIG. 2C may be arranged to be buried below surrounding side parts 13S by a preset depth. Accordingly, only a portion of a top 10T of the key 10 may be flat, whereas surrounding portions of the top 10T may be slanted along a preset angle toward sides 10S. By the same token, each of surrounding side parts 10S may define a slanted portion which extends upwardly from one edge of the center part 13C and a vertical portion extending downwardly to its side 10S. It is appreciated that such a center part 13C may readily be identified by the user and may easily receive the input force therefrom. Accordingly, the center part 13C may be assigned with a character more frequently used than other characters assigned to other side parts 12S. Other configurational and/or operational characteristics of the key of FIG. 2C may be identical or similar to those of the key of FIGS. 2A and 2B.

FIG. 2D is a schematic diagram of another exemplary key defining a center part and three side parts therearound according to the present invention. Similar to those of FIGS. 2A to 2C, an exemplary key 10 has a shape of a cube and defines a single center part 13C on its top 10T. The key 10 further defines three side parts 13S around the center part 13C so that the center part 13C may be disposed in a center of the top 10T of the key 10 and forms a square or rectangular shape and that one end of the center part 13C may extend outwardly to an edge which adjoins a side of the key 10. Each of the side parts 13S extends outwardly from one edge of the center part 13C to a corresponding side 10S. Such parts 13C, 13S may also be arranged to be separated from each other and to define a gap 11G between neighboring parts in order to help the user physically identify one of such parts from the rest thereof and, more importantly, to allow individual movement of each part between its rest position and its active position at least partially independent of the rest of such parts. In the embodiment shown in FIG. 2D, the center part 13C may have a shape of a rod having the same square or rectangular cross-section as exposed in the top 10T of the key 10, while each of the side parts 13C, 13S may form a rod with the same trapezoidal cross-section as exposed in the top 10T thereof. Therefore, the gaps 11G formed between the center part 13C and each of the side part 13S are generally vertical and maintain an uniform distance along a vertical axis of the key 10. It is to be understood that such multiple parts of the multi-part key 10 may be arranged to move in different, similar or identical directions in response to input forces applied by the user to different parts 13C, 13S of the key 10. Each of such parts 13C, 13S may be assigned with a different character such that the user may apply only single input force to a specific part 13C, 13S of the key in order to select such a character which may be assigned to such a part 13C, 13S. Details of various movements of the multi-part key 10 in response to the input forces and details of character arrangements thereon will also be described in greater detail below. Other configurational and/or operational characteristics of the key shown in FIG. 2D may be identical or similar to those of FIGS. 2A to 2C.

FIG. 2E is a schematic diagram of another exemplary key similar to that of FIG. 2D but having a center part raised over three side parts according to the present invention. Contrary to the key of FIG. 2D defining a flat top, a center part 13C of an exemplary key 10 shown in FIG. 2E may be arranged to be raised above or over surrounding side parts 13S by a preset elevation. Therefore, only a portion of a top 10T of the key 10 may be flat, whereas surrounding portions of the top 10T may be slanted in a preset angle toward sides 10S. It follows that the center part 13C may be deemed as a complex of the center part and one side part of FIG. 2B and that each of surrounding side parts 13S may define a slanted portion extending downwardly from one edge of such a center part 13C and a vertical portion also extending downwardly to its side 10S. In an alternative embodiment as shown in the figure, the center part 13C may extend to an edge which adjoins a side 10S of the key 10 so that the center part 13C may be bordered by a flat surface on the top 10T and by a vertical surface on the side 10S. It is appreciated that the center part 13C may readily be identified by the user and may easily receive the input force therefrom. Accordingly, such a center part 13C may be assigned with a character more frequently used than other characters assigned to the side parts 13S. Other configurational and/or operational characteristics of the key of FIG. 2E may be identical or similar to those of the key shown in FIG. 2D.

FIG. 2F is a schematic diagram of another exemplary key similar to that of FIG. 2D but having a center part buried below three side parts according to the present invention. A center part 13C of an exemplary key 10 shown in FIG. 2E may be buried below side parts 13S disposed therearound by a preset depth. Therefore, only a portion of a top 10T of the key 10 may be flat, whereas surrounding portions of the top 10T may be slanted in a preset angle toward sides 10S. It follows that the center part 13C may be deemed as a complex of the center part and one side part of FIG. 2C and that each of surrounding side parts 10S may define a slanted portion which may extend downwardly from one edge of the center part 13C and a vertical portion which may extend downwardly to its side 10S. In an alternative embodiment as shown in the figure, the center part 13C may extend to an edge which adjoins a side 10S of the key 10 such that the center part 13C may be bordered by a flat surface on the top 10T and by a vertical surface on the side 10S. It is appreciated that the center part 13C may readily be identified by the user and easily receive the input force therefrom. Accordingly, the center part 13C may be assigned with a character more frequently used than other characters which may be assigned to the side parts 13S. Other configurational and/or operational characteristics of the key of FIG. 2F may be identical or similar to those of the key shown in FIGS. 2D and 2E.

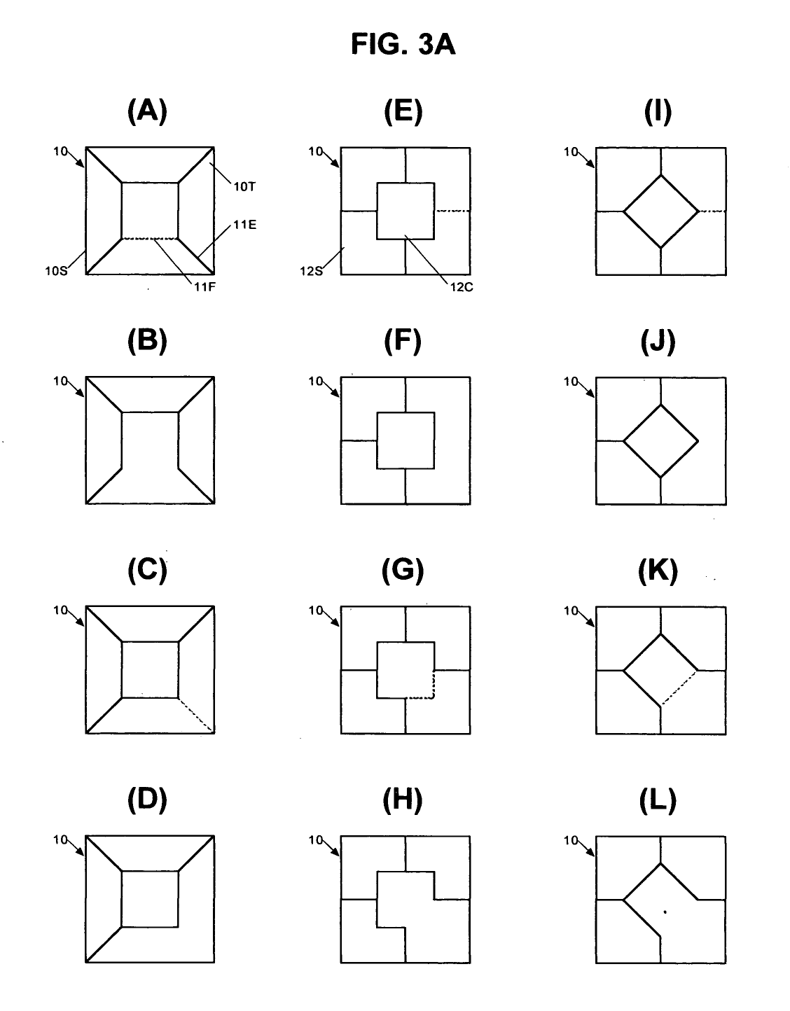

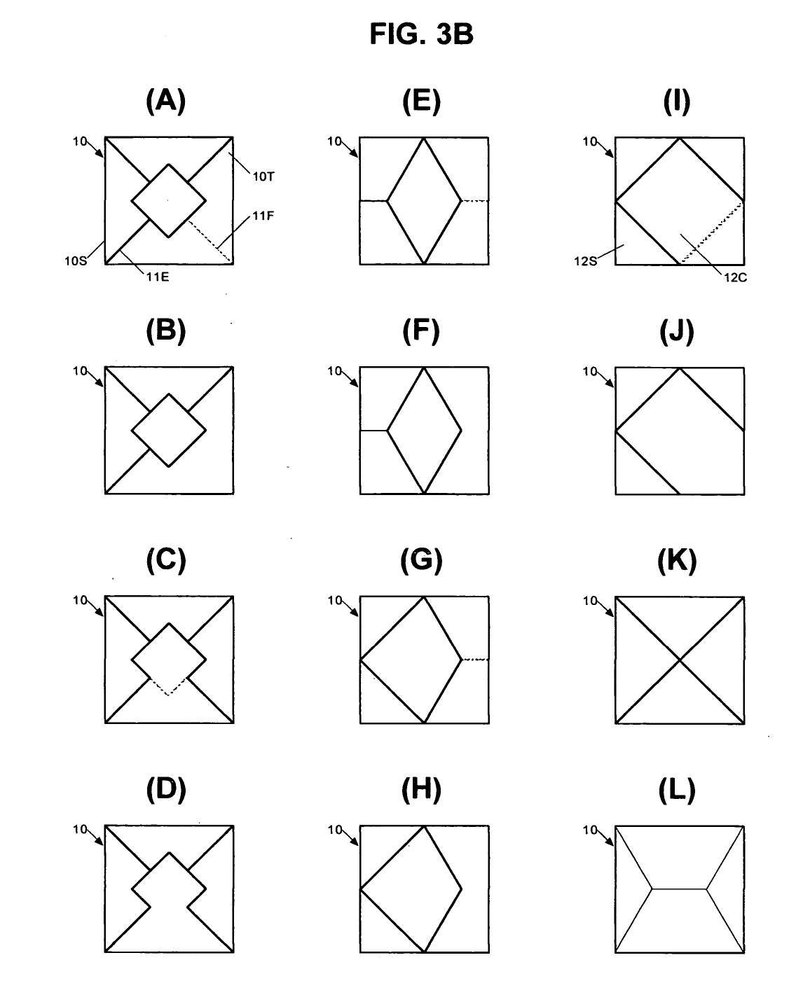

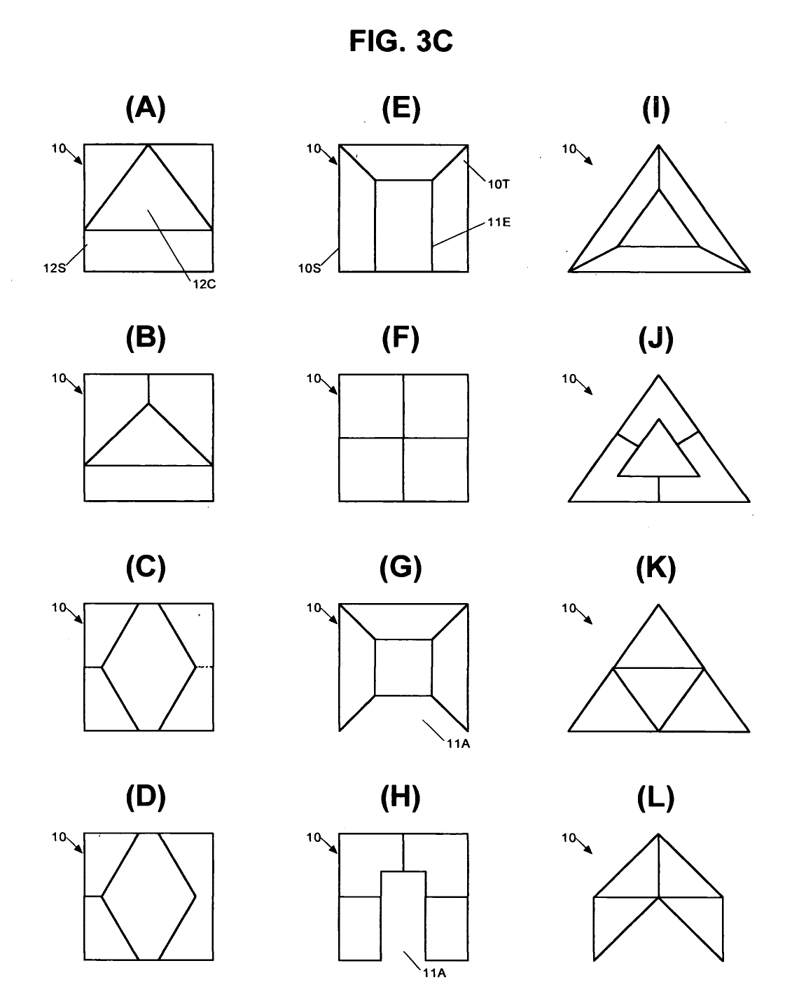

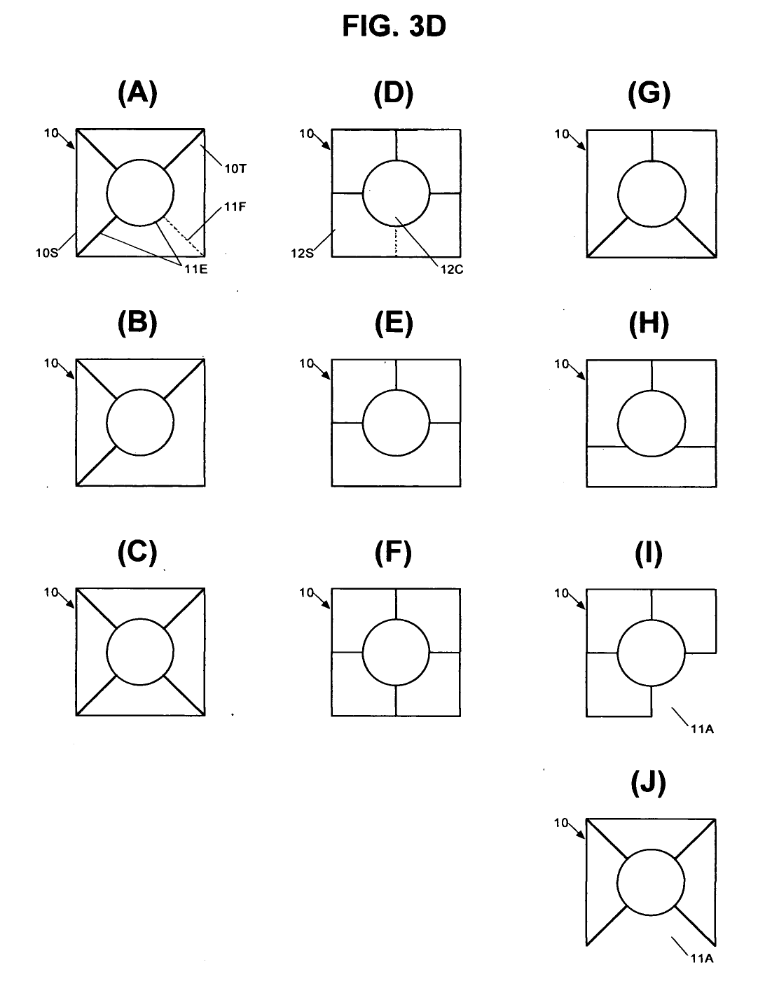

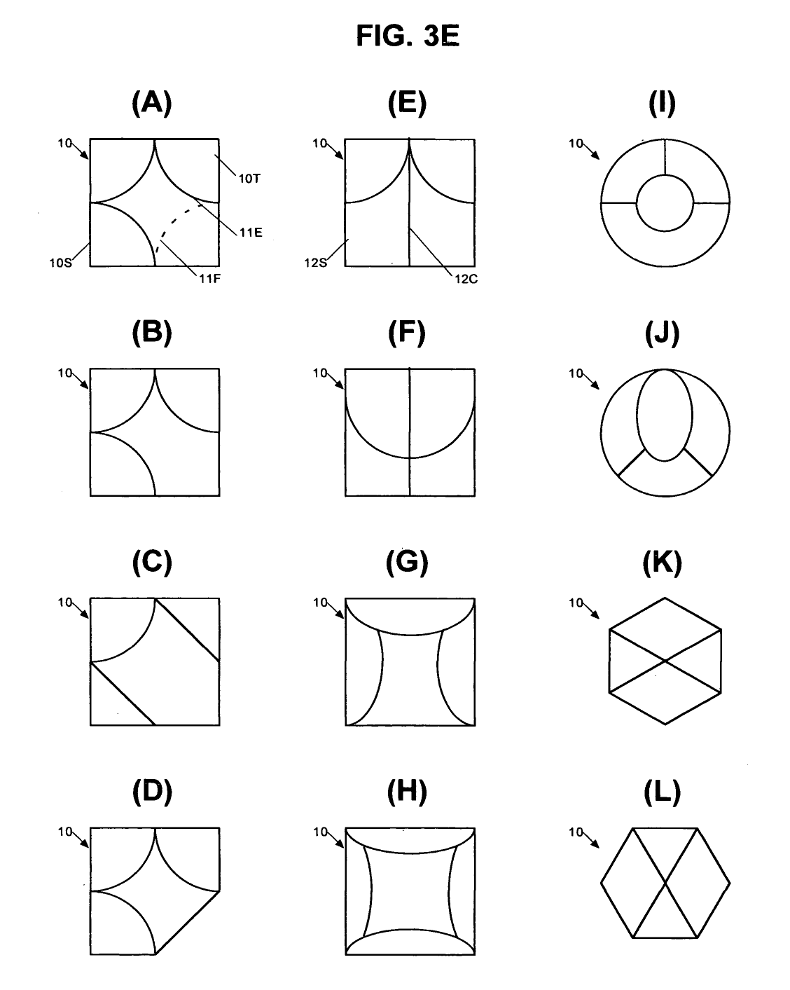

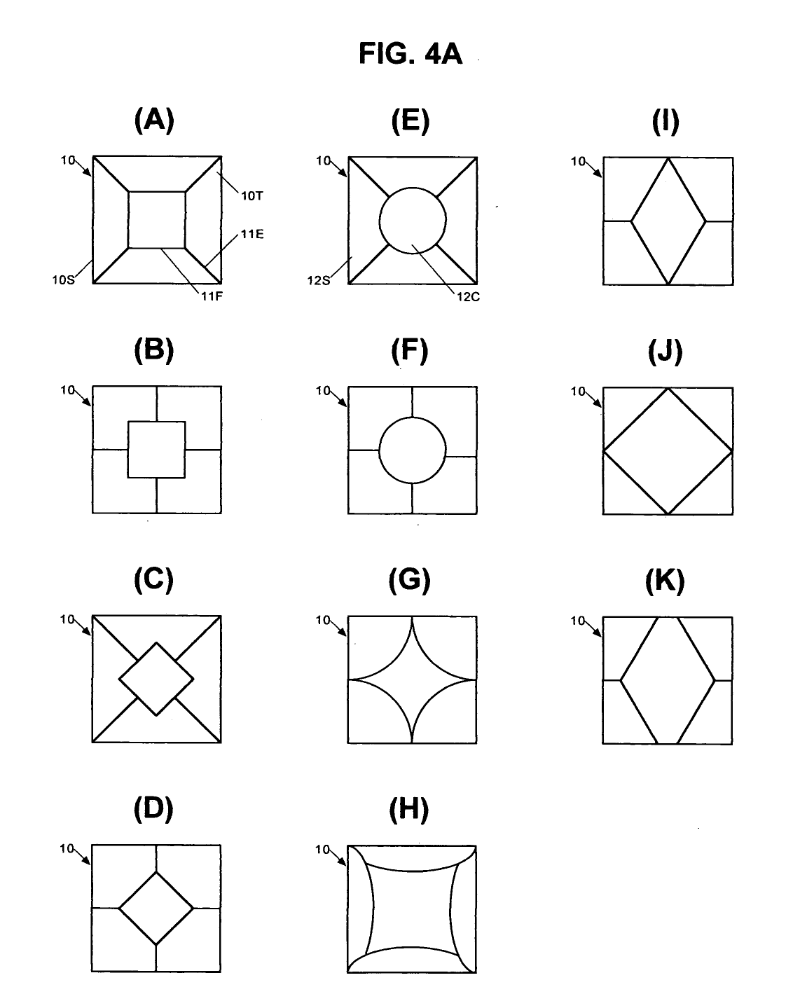

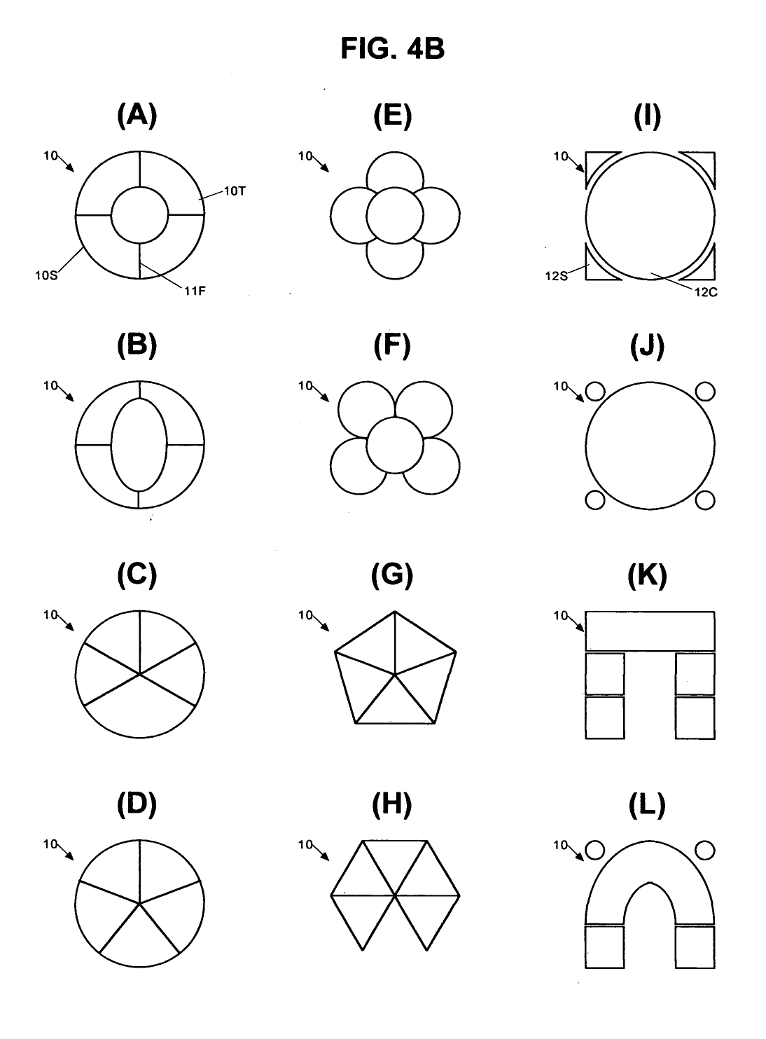

In another aspect of the present invention, various keys may also be arranged to form multiple sections-and/or parts thereon onto each of which a different characters may be assigned. In general, various keys of such an aspect of the present invention may have various polygonal, circular or oval shapes. Various sections and/or parts thereof may be disposed on different areas of such a key and have shapes exemplified in FIGS. 1A through 2F or other shapes. Similar to the above examples, such a key generally defines a top 10T, a bottom 10B, and multiple sides 10S, in which center sections 12C (or center parts 13C) and side sections 12S (or side parts 13S) may be arranged in different areas or portions of the top 10T and sides 10S of the key 10. Following FIGS. 3A through 3E and FIGS. 4A and 4B all describe top views of exemplary embodiments of such keys and sections and/or parts thereof. Although these figures only describe various keys having multiple sections, it is to be understood that such figures may instead be interpreted for various keys which have multiple parts instead of multiple sections. It is also appreciated that, as described in FIGS. 1A through 2F, various top views of those keys exemplified in FIGS. 3A through 3E and FIGS. 4A and 4B mays also have various configurations such as, e.g., flat tops, tops with their center portions raised over their side portions, tops with their center portions buried below their side portions, combinations of the above, and the like. Accordingly, each of the following FIGS. 3A to 3E and FIGS. 4A and 48 may preferably be interpreted to exemplify various embodiments for arrangements of such sections and/or parts, their shapes and/or sizes, and the like.

FIG. 3A is top views of exemplary keys defining four sections similar to those of FIGS. 1D to 1F and 2D to 2F, where each of panels (A) through (L) represents different embodiments of the sections according to the present invention.

In the embodiments of the panels (A) to (D), such a key 10 has a square or rectangular shape, where its center section 12C also has a similar but smaller square or rectangular shape. Various side sections 12S thereof may be defined by demarcating edges 11E which may be formed by connecting each of vertices of the center section 12C with each of corresponding vertices of the key 10. More specifically and in the embodiment of the panel (A), a center section 12C may be defined in a center of the key 10 and extend one of its edge toward a side 10S of the key 10 as exemplified by an edge 11F which may provide distinct sensation to an user. Three side sections 12S may then be formed around such a center section 12C. In the embodiment of the panel (B), the key 10 may have a center section 12C and side sections 12S which may be generally identical to those of the panel (A), except that the former 12C may extend smoothly from the center of the key 10 to the side thereof without forming the edge. In the embodiment of the panel (C), a center section 12C may be defined only in a center of the key 10, while three side sections 12S are defined around the center section 12C and along sides 10S of the key 10. One of the side sections 12S may also be arranged occupy a larger portion or area by, e.g., bordering two adjacent sides 108 of such a key 10. In the embodiment of the panel (D), a center section 12C and side sections 12S are defined to be identical to those of the panel (C), except that an edge may not be formed along the bigger side section 12S.

Still referring to FIG. 3A and in the embodiments of the panels (E) to (H), a key 10 has a square or rectangular shape, and its center section 12C also has a similar but smaller square or rectangular shape. Various side sections 12S of such a key 10 may be defined by demarcating edges 11E which may be formed by connecting each of centers of the center section 12C with each of corresponding centers of the key 10. More specifically and in the embodiment of the panel (E), a center section 12C may be defined in a very center of the key 10, thereby defining four truncated squares or rectangles therearound, where each of two of such truncated polygons forms one side section 12S and where the remaining two of such truncated polygons forms a single side section 12S which may include an edge 11F therebetween. A center section 12C and side sections 12S of the embodiment of the panel (F) are generally identical to those of the panel (E), except that an edge is not provided between two truncated polygons forming a single side section 12S. In the embodiment of the panel (G), the key 10 may similarly define four truncated polygons around the sides 10S of the key 10, where each of such three polygons forms one side section 12S and where a center section 12C is defined in the center of the key 10 and then extends to the remaining polygon. Such a center section 12C may also include an edge 11G between the center of the key 10 and the polygon thereof. A center section 12C and side sections 12S of the embodiment of the panel (H) are identical to those of the panel (G), except that an edge is not provided between the center of the key and polygon of the center section 12C.

Still referring to FIG. 3A and in the embodiments of the panels (I) to (L), a key 10 has a square or rectangular shape, but its center section 12C has a shape of a diamond or rhombus with a smaller size. Various side sections 12S of such a key 10 may be defined by demarcating edges 11E which may be formed by connecting each of vertices of the center section 12C with each of centers of the key 10. More specifically and in the embodiment of the panel (I), a center section 12C may be defined in the center of the key 10, thereby defining four truncated polygons therearound, where each of two of the truncated polygons forms one side section 12S, whereas the remaining two of such truncated polygons forms a single side section 12S which forms an edge 11F therebetween. A center section 12C and side sections 12S of the embodiment of the panel (J) may typically be identical to those of the panel (I), except that an edge may not be formed between two truncated polygons defining a single side section 12S. In the embodiment of the panel (K), the key 10 similarly has four truncated polygons around the sides 10S of the key 10, where each of such three polygons forms one side section 12S, while a center section 12C is defined in the center of the key 10 and further extends to the remaining polygon. Such a center section 12C may also include an edge 11G between the center of the key 10 and the polygon thereof. A center section 12C and side sections 12S of the embodiment of the panel (L) are identical to those of the panel (K), except that such an edge may not be provided between the center of the key and polygon of the center section 12C.

FIG. 3B is top views of other exemplary keys defining four sections similar to those of FIGS. 1D to 1F and 2D to 2F, where each of panels (A) to (L) represents different embodiments of the sections according to the present invention.

Similar to the panels (I) to (L) of FIG. 3A and in the embodiments of the panels (A) to (D) of FIG. 3B, a key 10 has a square or rectangular shape, but its center section 12C has a shape of a diamond or a rhombus having a smaller size. Various side sections 12S of such a key 10 may also be defined by demarcating edges 11E formed by connecting each center of sides of the center section 12C with each vertex of the key 10. More specifically and in the embodiment of the panel (A), a center section 12C may be defined in the center of the key 10, thereby defining four truncated polygons therearound, where each of two of the truncated polygons forms one side section 12S, while the remaining two of such truncated polygons forms a single side section 12S which forms an edge 11F therebetween. A center section 12C and side sections 12S of the embodiment of the panel (B) may typically be identical to those of the panel (A), except that an edge is not formed between two truncated polygons defining a single side section 12S. In the embodiment of the panel (C), the key 10 similarly forms four truncated polygons around the sides 10S of the key 10, where each of such three polygons may form one side section 12S, whereas a center section 12C is defined in the center of the key 10 and further extends to the remaining polygon. Such a center section 12C may include an edge 11G between the center of the key 10 and the polygon thereof. A center section 12C and side sections 12S of the embodiment of the panel (D) are identical to those of the panel (C), except that an edge may not be provided between the center of the key and polygon of the center section 12C.

Still referring to FIG. 3B and in the embodiments of the panels (E) to (H), a key 10 has a square or rectangular shape, and its center section 12C has a shape of a diamond or rhombus with a smaller size. Moreover, the center section 12C also extends upwardly and downwardly in order to contact an upper side 10S and a lower side 10S of the key 10, respectively, thereby forming four trapezoids around each corner of the key 10. More specifically and in the embodiment of the panel (E), a center section 12C may be defined in a very center of the key 10, where each of two trapezoids forms one side section 12S in neighboring corners and where the remaining two of such trapezoids merge and form a single side section 12S which may include an edge 11F therebetween. A center section 12C and side sections 12S of the embodiment of the panel (F) are generally identical to those of the panel (E), except that an edge is not provided between two trapezoids forming a single side section 12S. In the embodiment of the panel (G), a center section 12S may be arranged to contact three sides 10S of the key 10. Therefore, formed between the center section 12S and four sides 10S of the key 10 are two triangles and two trapezoids therebetween, where each of such triangles forms one side section 12S, while two trapezoids merge and form a single side section 12S which may include therebetween an edge 11F. In the embodiment of the panel (H), two side sections 12S disposed on a left side of the key 10 and a center section 12C are generally identical to those shown in the panel (G), while the last side section 12S on the right side of the key 10 is similar to that of the panel (G) but does not have an edge.

Still referring to FIG. 3B and in the embodiments of the panels (I) and (J), a key 10 also forms a square or rectangular shape, and its center section 12C has a shape of a diamond or rhombus which contacts all four sides 10S of the key 10, thereby defining four triangles between itself and four sides 10S. In the embodiment of the panel (I), the center diamond merges with one of the triangle and forms the center section 10S with a shape of a pentagon, where an edge 1 IF is also defined between such a center diamond and triangle. Each of the remaining three triangles then forms one side section 12S. Such sections 12C, 12S of the embodiment of the panel (J) are typically identical to those of the panel (I), except that an edge is not provided between a center rhombus and a neighboring triangle both of which form the center section 12C.

Still referring to FIG. 3B and in the embodiments of the panels (K) and (L), a key 10 is a square or a rectangle and a center section 12C and three side sections 12S are defined on each side of such a key 10. In the embodiment of the panel (K), the key 10 is divided into four equal sections by both of its diagonals, where one may serve as the center section 12C, whereas the other three may serve as the side sections 12S. In the embodiment of the panel (L), the key 10 is also divided into four sections, where two trapezoidal major sections are defined along an upper side and a lower side of the key 10, while two triangular minor sections are defined along a left side and right side of the key 10. Any one of such sections may be recruited as the center section 12C, while the remaining three may be used as the side sections 12S.

FIG. 3C is top views of other exemplary keys defining four sections similar to those of FIGS. 1D to 1F and 2D to 2F, where each of panels (A) to (L) represents different embodiments of the sections according to the present invention.

In the embodiments of the panels (A) and (B), a key 10 defines a square or rectangular shape, and contains therein a triangular center section 12C. In the embodiment of the panel (A), each vertex of the center section 12C is arranged to contact a side 10S of the key, thereby defining two triangles and a rectangle (or square) between itself and sides 10S of the key 10. Three side sections 12S are then defined in each of such triangles and rectangle. In the embodiment of the panel (B), only two of three vertices of the center section 12C are arranged to contact the adjacent sides 10S of the key 10, thereby defining two trapezoids and a rectangle (or square) between itself and sides 10S of the key 10. Three side sections 12S are similarly defined in each of such trapezoids and rectangle.

In the embodiments of the panels (C) and (D), a key 10 defines a square or rectangular shape, and contains therein a hexagonal center section 12C, where two opposing sides of the center section 12C may contact two opposing sides of the key 10, thereby defining four trapezoidal zones in each of four corners of the key 10. In the embodiment of the panel (C), each of two trapezoidal zones located on one side of the key 10 defines a single side section 12S, while the other two on an opposite side of the key 10 merge and form a single third side section 12S, while having an edge 11F therebetween. In the embodiment of the panel (D), the center and side sections 12C, 12S are similarly defined, except that a major side section 12S on the right side of the key 10 may not include any demarcating edge.

In the embodiment of the panel (E), a key 10 may have a square or rectangular shape, where a square or rectangular center section 12C is arranged to be formed inside the key 10 but to contact a side 10S of the key 10. A remaining area of the key 10 is divided into three trapezoidal zones each of which is defined as a single side section 12S. In the embodiment of the panel (F), a key 10 also has a square or rectangular area which is divided into four identical or similar squares or rectangles each of which may serve as a center section 12C or a side section 12S.

In the embodiment of the panel (G), a key 10 may gave a square or rectangular center section 12C. Disposed around three sides of the center section 12C are three similar or identical trapezoidal side sections 12S. Therefore, such a key 10 may provide a space 11A through which the user may easily locate and/or access different sections 12C, 12S thereof without having to visually locate such sections 12C, 12S. In the embodiment of the panel (H), a key 10 defines two hexagonal portions and two rectangular (or square) sections, while defining an access space 11A between the rectangular portions. Therefore, each of such portions may be used as one of different sections 12C, 12S while enabling the user to easily locate and/or access such sections 12C, 12S.

Still referring to FIG. 3C and in the embodiments of the panels (I) to (K), a key 10 may define a triangular area in which a center section 12C may be disposed. In the embodiment of the panel (I), the center section 12C is arranged to have a shape similar to that of the key 10 and to be disposed inside such a key 10 so that three sides of the center sections 12C may be parallel with or not substantially transverse to those 10S of the key 10. Three side sections 12S of such a key 10 may then be formed by connecting each vertex of such a center section 12C to a neighboring vertex of the key 10. In the embodiment of the panel (J), the center section 12C may generally be identical to that of the panel (I), but three side sections 12S are formed by connecting a center of each side of the center section 12C to a center of a neighboring side 108 of the key 10. In the embodiment of the panel (K), such a center section 12C is disposed upside down with respect to the key 10 and arranged to contact three sides 10S of the key, where each side section 12S may be defined in each triangle formed between such a center section 12C and key 10.

In the embodiment of the panel (L), a key 10 may have a shape of an arrow head composed of four similar or identical triangles. A center section 12C and three side sections 12S may be defined in each of such triangles. It is appreciated that the key 10 may also provide another access space 11A between opposing triangles through which the user may easily identify and manipulate each of such sections 12C, 12S.

FIG. 3D is top views of other exemplary keys defining four sections similar to those of FIGS. 1D to 1F and 2D to 2F, where each of panels (A) to (J) represents different embodiments of the sections according to the present invention. It is to be understood that each exemplary key of such panels has a round (e.g., circular, oval or otherwise curvilinear) center section therein and also forms three side sections around such a center section.

In the embodiments of the panels (A) through (C), a key 10 has a square or rectangular shape and includes a round center section 12C without preferably contacting any side 10S of such a key 10. In the embodiment of the panel (A), the center section 12C divides a remaining area of the key 10 into four regions by four partial diagonals connecting each vertex of the key 10 toward a center of such a center section 12C, thereby forming four curvilinear trapezoids each including one arcuate side. Each of two neighboring trapezoids forms a side section 12S, and the remaining two trapezoids merge and form a third side section 12S which also includes an edge 11F between the joining trapezoids. In the embodiment shown in the panel (B), a center section 12C and three side sections 12S may similarly be defined, except that a side section 12S formed by two merged trapezoids may not include an edge. In the embodiment of the panel (C), the key 10 forms a similar center section 12C and defines similar four trapezoids. Such a key 10, however, may form two side sections 12S in opposing trapezoids, while the remaining two opposing trapezoids may be arranged to perform the same function and, therefore, serve as a single side section. Such an embodiment may provide the user with flexibility in performing various preset functions such as, e.g., selecting a preset character both of which are assigned to a pair of opposing curvilinear trapezoidal areas, simply through applying the input force to either of such areas.

In the embodiments of the panels (D) to (F), a key 10 may have a square or rectangular shape and include a round center section 12C preferably without contacting any side 10S of such a key 10. In the embodiment of the panel (D), the center section 12C divides a remaining area of the key 10 into four areas by four lines connecting centers of each side 10S of the key 10 toward a center of such a center section 12C, thereby forming four curvilinear squares or rectangles each including one arcuate side. Each of two neighboring curvilinear squares defines a side section 12S, and the remaining two curvilinear squares merge and form a third side section 12S which includes an edge 11F between the adjacent curvilinear squares. In the embodiment of the panel (E), one center section 12C and two side sections 12S may similarly be defined, except that a third side section 12S formed by two curvilinear squares may not include an edge. In the embodiment of the panel (F), the key 10 may include a similar center section 12C and define similar four curvilinear squares. Such a key 10, however, may define two side sections 12S in opposing curvilinear squares, whereas the remaining two may be arranged to perform the same function and, therefore, serve as a single side section. Such an embodiment may provide the user with flexibility in performing various preset functions such as, e.g., selecting a preset character both assigned to a pair of opposing curvilinear square areas, simply by applying such input force to either of such areas.

In the embodiments of the panels (G) and (H), a key 10 has a square or rectangular shape and include a round center section 12C without contacting any side 10S of the key 10. In the embodiment of the panel (G), the center section 12C divide a remaining area of such a key 10 into three regions by a vertical line passing through a center of an upper side 10S of the key 10 and a center of the key 10 and a pair of lines each passing through a vertex of a lower side 10S of the key and pointing toward the center of the key 10. Each of those three divided areas then serves as a side section 10S of the key 10. In the embodiment of the panel (H), the center section 12C may divide the rest of the area of the key 10 into three regions by one vertical line and a pair of horizontal lines, and each of the divided areas may serve as a side section 10S of the key 10.

Still referring to FIG. 3D and in the embodiments of the panels (I) and (J), a key 10 may have an access space 11A similar to those keys of the panels (H) and (L) of FIG. 3C. In the embodiment of the panel (I), the key 10 is similar to that of the panel (F), i.e., forming a center section 12C and three side sections 12S therearound. The key 10, however, may not include a square or rectangular region in a lower right corner thereof, thereby forming the access space 11A thereon. In the embodiment of the panel (J), the key 10 is similar to that of the panel (C), i.e., forming a center section 12C and three side sections 12S therearound. Such a key 10 may not include a curvilinear trapezoidal region in a lower right corner thereof, thereby forming another access space 11A thereon. Such access spaces 11A may enable the user to readily identify one of the sections 12C, 12S and/or to easily access such.

FIG. 3E is top views of other exemplary keys defining four sections similar to those of FIGS. 1D to 1F and 2D to 2F, where each of panels (A) to (L) represents different embodiments of the sections according to the present invention.

In the embodiments of the panels (A) to (C), a key 10 generally defines a square or rectangular shape. A center region is defined inside the key 10 while touching centers of all four sides 10S of the key, while four quarter circles are disposed in each corner of the key 10 and around the above center region. Thus, the center region is shaped as a curvilinear diamond or a rhombus. In the embodiment of the panel (A), each of three quarter circles serves as each of three side sections 12S, while such a center region and the last quarter circle merge and serve as a center section 12C and form an edge 11F therebetween. In the embodiment of the panel (B), a center section 12S and three side sections 12S are formed similar to those of the panel (A), except that the merging center section 12C and last side section 12S do not define any edge therebetween. In the embodiment of the panel (C), one side section 12S has a shape of a quarter circle, while two side sections 12S have shapes of triangles. A center section 12S is formed by a center region and a corner of the key 10. In the embodiment of the panel (D), three side sections 12S are defined similar to those of the panels (A) and (B), whereas a center section 12C is defined in a center region of the key 10 and truncated in a lower right corner. The truncated corner may then be utilized as an access space as described above.

In the embodiments of the panels (E) to (H), a key 10 defines a shape of a square or rectangle in and/or along which various curvilinear sections may be formed. In the embodiment of the panel (E), an entire area of the key 10 may be symmetrically divided into a left region and a right region and each of such regions may then be divided into an upper quarter circle and a remaining lower zone. Each of such quarter circles and lower parts may serve as either a center section 12C or a side section 12S. In the embodiment of the panel (F), the key 10 may be similarly divided into two symmetric regions, and each region may be further divided into an upper area and a lower area. Each of such areas may be utilized as either a center section 12C or a side section 12S. In the embodiment of the panel (G), the key 10 includes three arcuate side sections 12S along three sides 10S thereof, where the remaining area of the key 10 may be defined as a center section 12C. In the embodiment of the panel (H), such a key 10 may define four arcuate regions along each side 10S thereof and a center section 12C in the remaining area of the key 10. In one example, each of three arcuate regions may be used as a single side section 12S, and the last arcuate region may merge into the center section 12C. In an alternative example, each of two of such arcuate regions may be used as a single side section 12S, and the last two arcuate regions may then be used as the last side section 12S by being assigned with the same character. Such last two arcuate regions may be selected as those adjacent to each other or those opposite to each other as described above.

In the embodiments of the panels (I) and (J), a key 10 defines a round (e.g., circular, oval, and so on) shape, in which a center section 12C is also defined to be round but to have a smaller size. In the embodiment of the panel (I), the center section 12C may be concentrically disposed inside the key 10, and the remaining area between such a section 12C and key 10 may be radially divided into three side sections 12S which may have the same area or different areas. In the embodiment of the panel (J), the oval center section 12C may be disposed inside the key 10 while contacting an upper side 10S of the key 10. The remaining area between such a center section 12C and key 10 may be divided into three side sections 12S.

In the embodiments of the panels (K) and (L), a key 10 defines a hexagonal shape which may be divided into four areas by two diagonals thereof, i.e., two triangles and two diamonds, where the latter is twice as big as the former. In the embodiment of the panel (K), such two diamond areas may be disposed one over the other, defining an upper region and a lower region, whereas two triangular areas may define a left region and a right region. Each of such regions may be recruited as a center section 12C and three side sections 12S. In the embodiment of the panel (L), two diamond areas are disposed side by side and two triangular areas are disposed one over the other, thereby defining one center section 12C and three side sections 12S.

In addition to the foregoing exemplary embodiments of various keys defining four sections one of which may serve as the center section and the rest of which may serve as the side sections, such keys may also be arranged to define five sections therein, where one of such sections may serve as the center section, while the remaining four sections may serve as the side sections.

FIG. 4A is top views of exemplary keys defining five sections similar to those of FIGS. 1A to 1C and 2A to 2C, where each of panels (A) through (K) depicts different embodiments of such sections according to the present invention. In all of such embodiments, each key 10 has a shape of a square or a rectangle, and defines a center section 12C and four side sections 12S therearound.

In the embodiments of the panels (A) to (D), the center section 12C defines a similar square or rectangular shape and is disposed inside an area defined by the key 10. Various embodiments of the panels (A) to (D) may be respectively similar to those of the panel (A) of FIG. 3A, the panel (E) of FIG. 3A, the panel (A) of FIG. 3B, and the panel (I) of FIG. 3A, except that such four side sections 12S may be defined around the center section 12C without any demarcating edges defined between such side sections 12S.

In the embodiments of the panels (E) to (H), the center section 12C has a similar round shape and is disposed inside the area of the key 10. Various embodiments of the panels (E) to (H) may be respectively similar to those of the panel (A) of FIG. 3D, the panel (D) of FIG. 3D, the panel (A) of FIG. 3E, and the panel (H) of FIG. 3E, except that such side sections 12S may be defined around the center section 12C without any demarcating edges therebetween.

In the embodiments of the panels (I) to (K), such a center section 12C may have one of various shapes, e.g., various embodiments of the panels (I) to (K) may be constructed respectively similar to those of the panel (E) of FIG. 3B, the panel (I) of FIG. 3B, and the panel (C) of FIG. 3C, except that the side sections 12S may be defined around the center section 12C without any edges therebetween.

FIG. 4B is top views of other exemplary keys defining five sections similar to those of FIGS. 1A to 1C and 2A to 2C, where each of panels (A) to (L) represents different embodiments of the sections according to the present invention.

In the embodiments of the panels (A) to (D), the key 10 has a round shape. In the embodiment of the panel (A), a center section 12S has a similar round shape but of a smaller size and a remaining area of the key 10 is radially divided into four regions each of which serves as a side section 12S. In the embodiment of the panel (B), a center section 12S has an oval shape, and a remaining area of the key 10 is similarly divided into four curvilinear regions each of which serves as a side section 12S. In the embodiment of the panel (C), the key 10 is radially divided into one major region which may serve as a center section 12C and four minor regions each of which may also serve as a side section 12S. In the embodiment of the panel (D), the key 10 may be radially divided into five similar regions, one of which serves as a center section 12C, while the rest thereof serve as side sections 12S.

In the embodiment of the panel (E), the key 10 is comprised of five circular areas, one of which serves as a center section 12C and the rest of which serve as side sections 12S. The area disposed in the center may generally be selected as the center section 12C. The embodiment of the panel (F) is generally similar to that shown in the panel (E), except that side sections 12S are disposed apart from each other by a small distance.

In the embodiment of the panel (G), the key 10 has a shape of a pentagon which is divided into five regions, one of which is selected as a center section 12C and the rest of which are selected as side sections 12S. In the embodiment of the panel (H), the key 10 has a shape of a hexagon which is open through one side, thereby forming five areas one of which may be used as a center section 12C and the rest of which may serve as side sections 12S. It is appreciated that the area for the missing side of the key 10 may be utilized as an access space as described hereinabove.

In the embodiments of the panels (I) to (L), the key 10 may include five parts each arranged to move with respect to the others. In each of the embodiments of the panels (I) and (J), the key 10 has a round center part 13C which is surrounded by four curvilinear side parts 13S which are disposed in each corner of the key 10. Such side parts 13S may have shapes of rods as exemplified in the panel (J) or shapes of curvilinear triangular pods as shown in the panel (I). In the embodiment of the panel (K), the key 10 has one major rectangular area and four minor rectangular areas which are disposed on each end of the major area in a row. Such major area may be assigned as a center part 13C, and the minor areas may be used as side parts 13S. In the embodiment of the panel (L), the key 10 has a horseshoe-shaped major area, two round minor areas, and two round minor areas, where the major area may be used as a center part 13C, and the minor areas as side parts 13S. It is to be understood that such side parts 13S may be arranged to be flush with the center part 13C, to be raised thereover or to be buried thereunder. Such side parts 13S may also be arranged in different elevations so as to facilitate the user to identify or distinguish one side part 13S from the rest. It is also appreciated that the keys 10 of the panels (K) and (L) may form access areas to facilitate the user to locate or identify such parts 13C, 13S of the key 10.

Such multi-section and/or multi-part keys of this invention may offer various advantages over conventional keys. Most importantly, such keys of this invention are location- or position-specific, i.e., an user may apply the input force to a specific section or part of the key in order to select a character which is assigned to such a section or part. Accordingly, whether such a character may be a lower case of an alphabet, an upper case of the alphabet, a numeral or a symbol, the user may select such a character without having to manipulate other keys such as, e.g., a shift key, a function key, and the like. In addition, the user may select multiple characters consecutively when such characters happen to be assigned to the single key. What all the user has to to is to consecutively apply the input forces to each of such sections or parts of the key and the characters can be selected, without having to hit other keys, without having to wait for a preset period of time, and so on. In addition, because of such location- or position-specific feature, the user may also select one character per each input force he or she delivers to such a section or part, which may greatly increase a speed of typing as well.

Configurational and/or operational variations and/or modifications of the above embodiments of the exemplary keys which may include multiple sections and/or parts also fall within the scope of this invention.

First, the multi-section or multi-part key of the present invention may be arranged to include any number of sections (or parts) thereon or thereover. Accordingly, in addition to such keys with four or five sections (or parts) as exemplified herein, such keys may be arranged to include two, three, six or seven sections (or parts) as long as such a provision may easily enable the user to individually apply the input force to each of such sections (or parts). As will be described below, some of the sections (or parts) of the same or different key may be assigned with the same character so as to provide the user with an option to apply the input force to any of such sections (or parts) while he or she wants to select the same character.

In this context, any number of such sections (or parts) of this invention may be deemed to be capable of merging into a new section (or part) and/or capable of being divided into a larger number of such sections (or parts). Accordingly, any exemplified embodiments described herein may readily be modified by replacing any key defining a preset number of the sections (or parts) with a different key defining a different number of such sections (or parts).

The above sections (or parts) of a key may be assigned with various characters according to a variety of arrangements. For example, only one of a section (or part) of a key may be provided with a single numeral, while each of the rest of such sections (or parts) may be provided with an alphabet or a symbol. In the alternative, such sections (or parts) of a key may be provided with only numerals, alphabets or symbols. In another alternative, such sections (or parts) of a key may also be provided with alphabets and symbols, but not numerals. Various arrangements of such keys will be provided in greater detail below. It is appreciated, however, that detailed arrangements of such characters to each of the sections (or parts) may also depend upon which set of numerals, symbols, and alphabets of a certain language the user desires to assign thereto.

Various sections (or parts) may typically be disposed on different areas of the keys such that the user may apply the input forces independently to each of such sections (or parts). For example, the center section (or part) may be disposed in or around a center of the key, while the side sections (or parts) may be disposed around such a center section (or part) and/or around the sides of the key. As long as each of such sections (or parts) may be able to receive the input force independent of the other sections (or parts), detailed arrangements of such sections (or parts) on the key, shapes and/or sizes of such sections (or parts), and spacing between such sections (or parts) may not be critical to the scope of the present invention.

It is appreciated that the above center section (or part) may not literally require such a section (or part) to be disposed in the very center of the key. Rather, such a center section (or part) may be deemed to correspond to a section (or part) assigned with a character which is more frequently used than those other characters assigned to multiple side sections (or parts) of the same key. Therefore, such a center section (or part) may be disposed along the side of the key. In addition, the center and side sections (or parts) may be arranged to various shapes and/or sizes. In one example, the center and side sections may be arranged to have similar or identical shapes and/or sizes which may also be disposed symmetrically or asymmetrically. In another example, such center and side sections may be arranged to have different shapes and/or sizes, where the former may preferably be arranged to be of a larger size. In yet another example, at least one of such side sections may be arranged to have a different shape and/or size from the rest thereof.

When the key includes at least two parts arranged to move with respect to and independently of each other, such parts of a given key may be arranged to be disposed closer to each other than to another part of another key, thereby forming a cluster or an aggregate thereof. In addition, such parts may be disposed in proximity, within a preset distance, and/or within a finger's grasp so that the user may be able to manipulate any parts of a single key simply by maneuvering his or her finger by a small distance, without having to move his or her hand at all. Such parts may be arranged to be enclosed in a housing in order to facilitate the user to identify those parts of a single key. In this embodiment, one part of a key may be disposed closer to another part of another key than other parts of the same key. In addition, opposing surfaces of such parts of a given key may be arranged to have contours which may be arranged to facilitate movement of one part with respect to others, to guide such movement of one part by others, and so on. When desirable, the key may also be arranged such that movement of a part beyond a preset extent may move an entire cluster or aggregate of such parts, thereby moving the entire key. In addition, a single key may also be arranged to define at least one section as well as at least one part thereon.

Various sections (or parts) of such keys may be provided in various elevations. For example, all of such sections (or parts) of a specific key may be arranged to be flush with each other or, in the alternative, at least one of such sections (or parts) of a given key may be arranged to be raised over or buried below the rest of such sections (or parts). When desirable, one of such sections (or parts) may be arranged in a specific (higher or lower) elevation across all of such keys in order to provide a different sensation to the user.

Various sections (or parts) of such keys may also be arranged to have different properties on their surfaces so as to aid the user to identify a specific section (or part) or differentiate one of such sections (or parts) from others. More particularly, at least one of such sections (or parts) may define a different inclination or angle relative to those of the others, a different texture with respect thereto, a different shape such as, e.g., a different number of sides and/or vertices, a different size, a different orientation, a different exposed area, a different contour, and the like. Such an embodiment may allow the user to identify or differentiate one section (or part) from the rest of such sections (or parts) only by touching or otherwise sensing such properties.

Various sections (or parts) of the multi-section (or multi-part) key of the present invention may be arranged to translate, rotate, pivot, and/or otherwise move between at least one rest position and at least one active position. In general, the rest position represents a position or a state of the section (or part) when the input force is not applied thereto, while the active position refers to a position or a state of the section (or part) when or while the input force is applied thereto. In general, the rest and active positions of one section (or part) may be different from the rest and active positions of others. When desirable, the rest (or active) position of one section (or part) of a preset key may be arranged to coincide with the rest (or active) position of another section (or part) of the same key. Various sections (or parts) may be arranged to move between such rest and active positions in various directions. For example, at least one of such sections (or parts) may move along a vertical direction, along a horizontal direction, along an angular or radial direction, and the like. As described heretofore, such movement of the section is generally the movement of an entire portion of the key in the sense that such a key with multiple sections is an unitary article. This, however, may not exclude a possibility that at least a portion of the key may remain relatively stationary while another portion of the same key may move between their rest and active positions. In contrary, such movement of the part is generally only the movement of such a part receiving the input force. This, however, may not exclude the possibility that such a part may be arranged to move an entire aggregate or cluster of the parts when a displacement of such a part may exceed beyond a certain distance.

Similarly, various sections (or parts) may be arranged to translate, rotate, and/or pivot along a variety of directions. For example, such sections (or parts) may translate or reciprocate along a linear or curved path, may rotate or pivot along a curvilinear path, and the like. In addition, such sections (or parts) may move along the direction of the input force, along another direction opposite to the direction of the input force, and/or along yet another direction at least partially transverse to a direction of such input force. These embodiments may readily be obtained by mechanically coupling such sections (or parts) using conventional force transmitting elements.

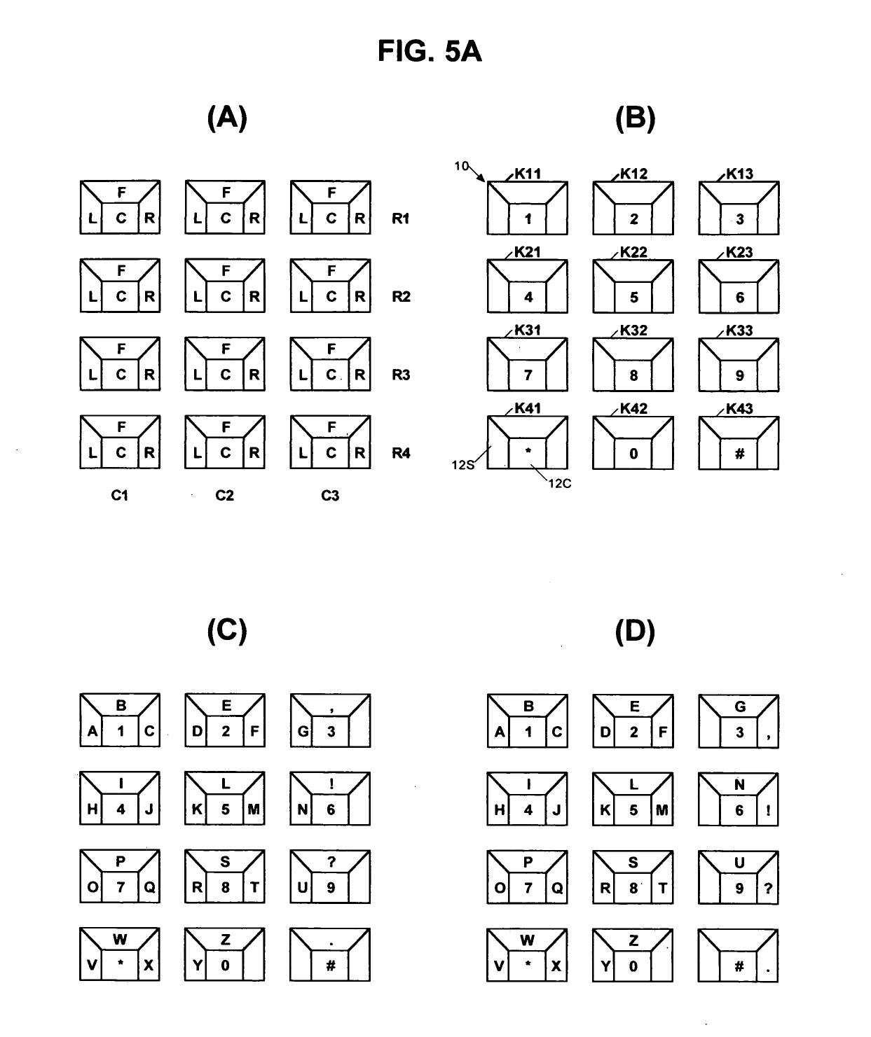

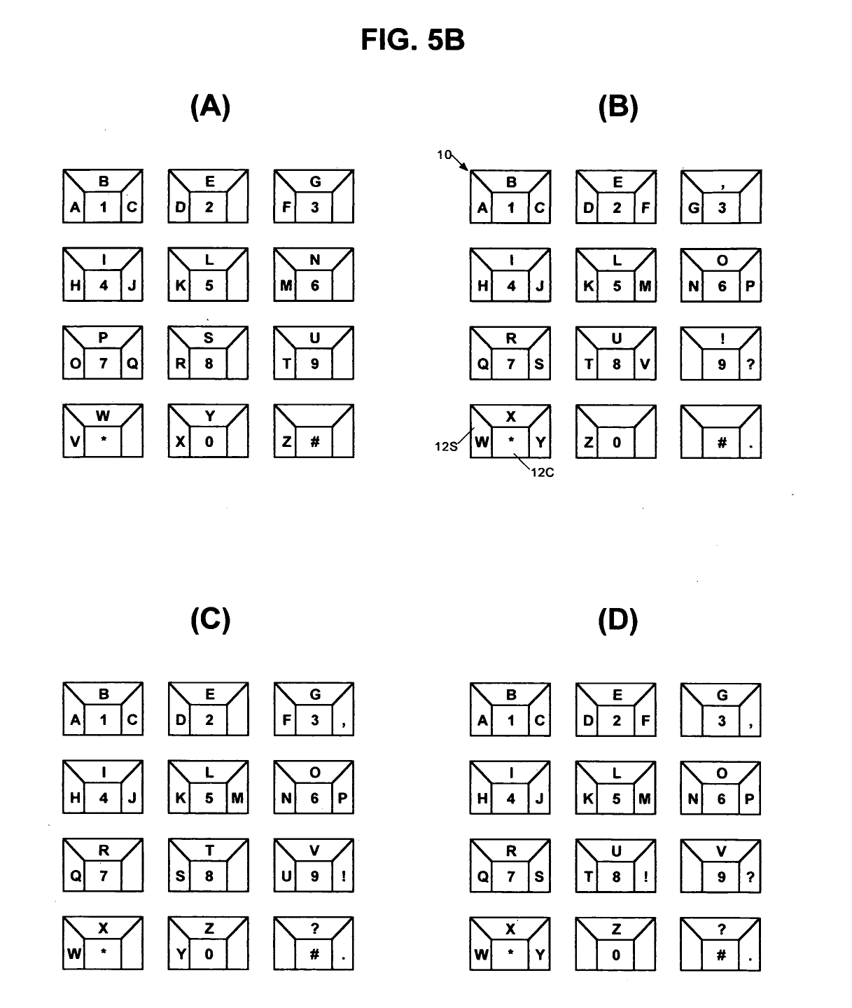

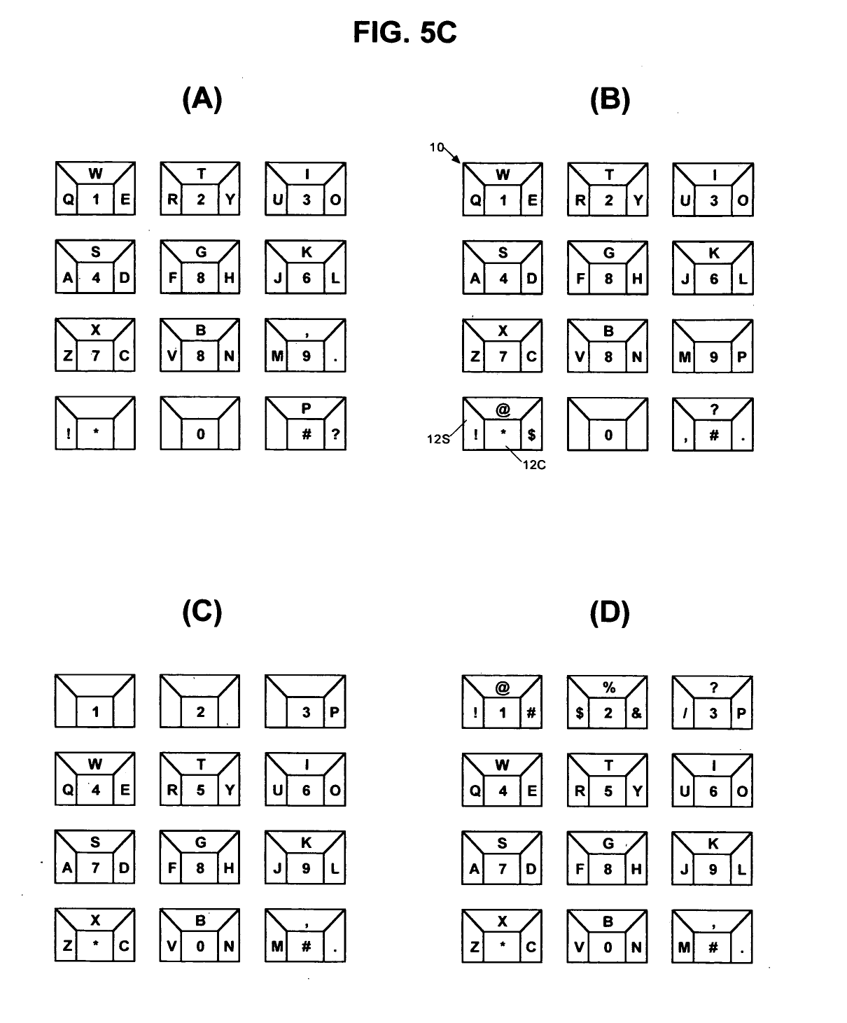

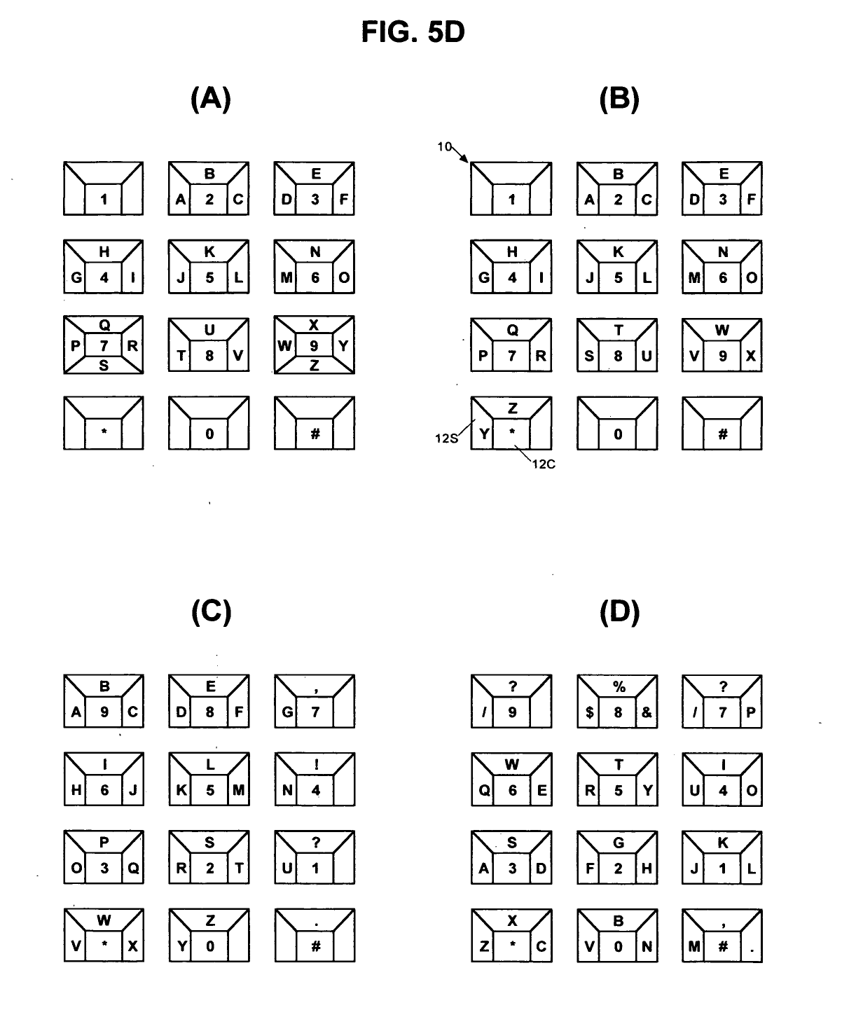

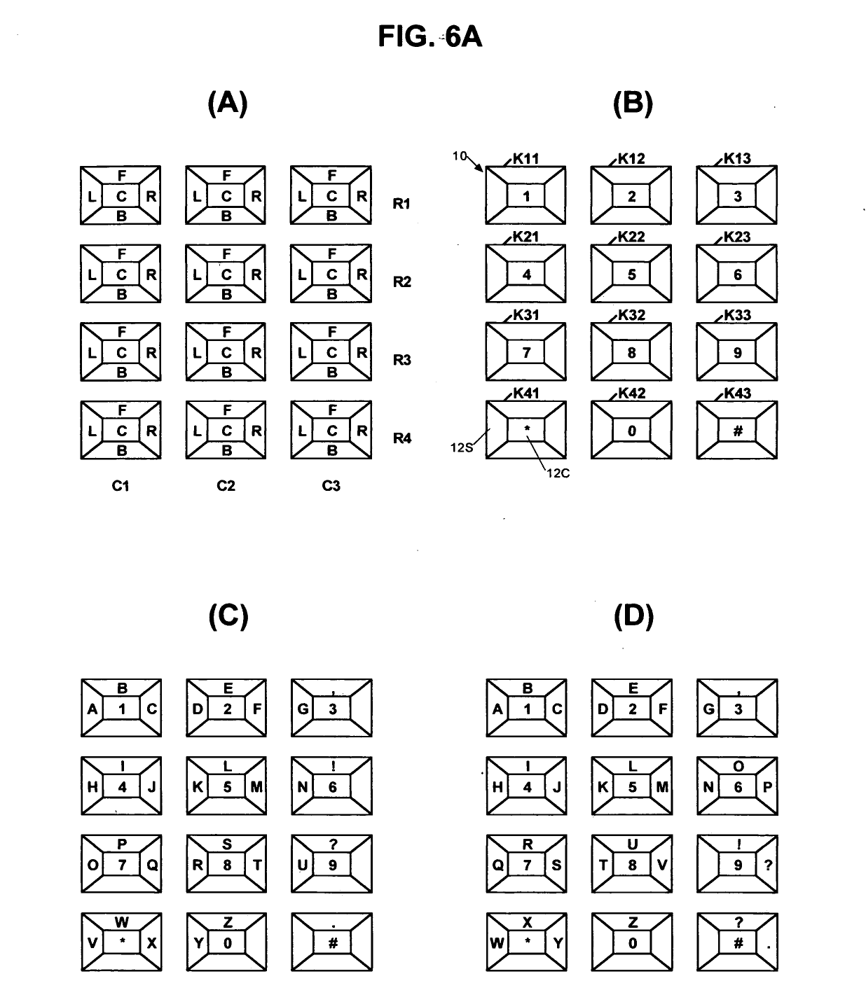

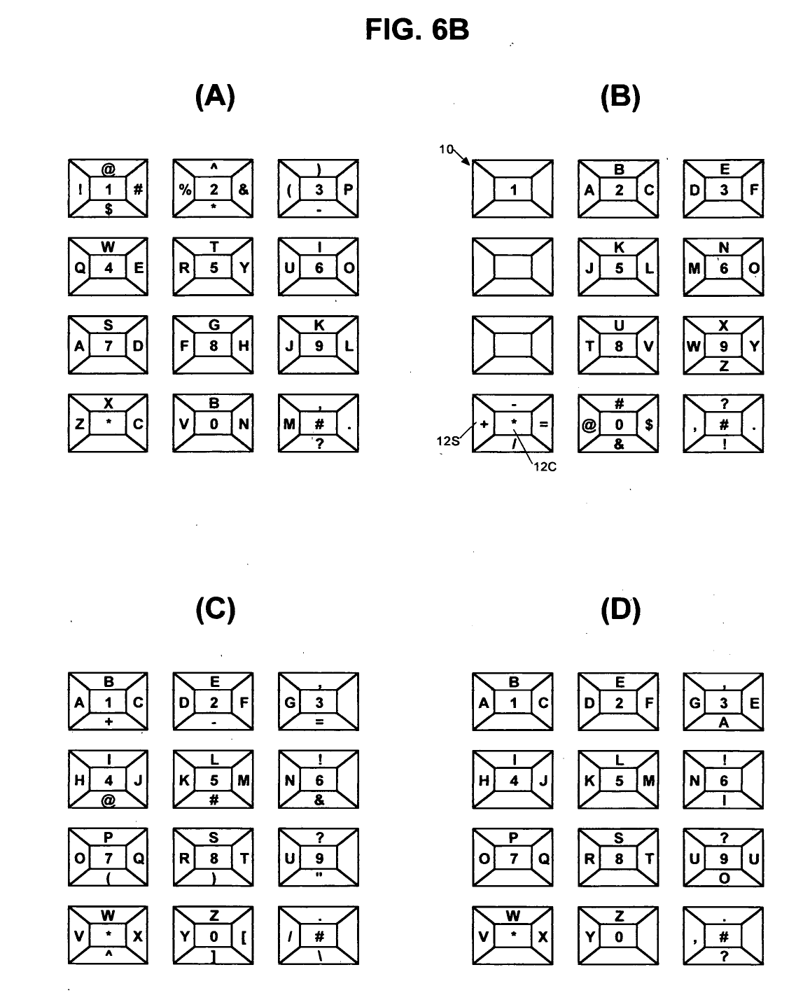

In another aspect of the present invention, various key assemblies may also be constructed by arranging the above keys of this invention in multiple rows and/or in multiple columns and by assigning different characters to their sections and/or parts in arrangements which may enable an user to type in various characters with ease and increased efficiency. Following FIGS. 5A to 5D and FIGS. 6A and 6B exemplify some arrangements of such multi-section or multi-part keys and/or assignments of such sections and/or parts with various characters.

FIG. SA is top views of keys defining four sections or parts which are assigned according to an exemplary arrangement of characters according to the present invention. The panels (A) and (B) describe a nomenclature for an exemplary arrangement of twelve keys according to a 4×3 matrix (i.e., a matrix with four rows and three columns), where each key may define four sections or parts on its top and/or side surfaces. According to this nomenclature, a key designated as “K23” refers to a key which is disposed in the second row and third column. In addition, a center section or part of such a key is to be represented by “C,” whereas three side sections or parts thereof are to be represented by “L (left),” “F (front),” and “R (right).” Accordingly, a section or part designated as “C-K14” refers to the center section or part of a key disposed on the first row and fourth column.

In the embodiment of the panel (B), ten numerals from 0 to 9 and two symbols, “* (a star)” and “# (a sharp)” are assigned to center sections or parts of the twelve keys, e.g., 1 to C-K11, 2 to C-K12, 3 to C-K13, 4 to C-K21, 5 to C-K22, 6 to C-K23, 7 to C-K31, 8 to C-K32, 9 to C-K33, 0 to C-K42, the star to C-K41, and the sharp to C-K43. More characters may also be assigned to other sections or parts of the keys which have not yet been assigned. In the embodiment of the panel (C), alphabets “A”, “B,” and “C” may be assigned to L-K11, F-K11, and R-K11, respectively, alphabets “D,” “E,” and “F” may be assigned to L-K12, F-K12, and R-K12, respectively, and then an alphabet “G” and a comma “,” may be assigned to L-K13 and F-K13, respectively. In the next row of the keys 10, alphabets “H,” “I,” and “J” may be respectively assigned to L-K21, F-K21, R-K21, alphabets “K,” “L,” and “M” may be assigned to L-K22, F-K22, and R-K22, respectively, and an alphabet “N” and an acclamation mark “!” are assigned to L-K23 and F-K23, respectively. In the next row of such keys 10, alphabets “O,” “P,” and “Q” may be assigned to L-K31, F-K31, and R-K31, respectively, alphabets “R,” “S,” and “T” may be respectively assigned to L-K32, F-K32, and R-K32, and an alphabet “U” and a question mark “?” may be assigned to L-K33 and F-K33, respectively. In the final row of the keys 10, alphabets “V,” “W,” and “X” may be assigned to L-K41, F-K41, and R-K41, respectively, alphabets “Y” and “Z” may be assigned to L-K42 and F-K42, respectively, and a period “.” may be assigned to F-K43. It is appreciated that the above key arrangement leaves various blank sections or parts such as R-K13, R-K23, R-K33, L-K43, and R-K43, which may then be assigned with other characters. Another key arrangement exemplified in the panel (D) is generally similar to that of the panel (C), except that alphabets and/or symbols of the third column of the keys 10 are filled from right to left, contrary to that of the panel (C).

FIG. 5B is top views of keys defining four sections or parts which are assigned according to other exemplary arrangements of characters according to the present invention. It is appreciated that the numerals from 0 to 9 and symbols such as “*” and “#” are assigned similar to those of FIG. 5A in all exemplary embodiments of this figure.

In the embodiment of the panel (A), alphabets are similarly arranged to those of the panels (C) and (D) of FIG. 5A, except that a blank section or part is provided in every second key in each row of the keys 10. Accordingly, such blank sections or parts are formed in R-K12, R-K13, R-K22, R-K23, R-K32, R-K33, R-K41, R-K42, F-K43, and R-K43. In the embodiment of the panel (B), alphabets from “A” to “Z” are classified into four groups based on a popular alphabet song such that alphabets from “A” to “G” are assigned to the first row of the keys 10, those from “H” to “P” are assigned to the second row thereof, those from “Q” to “V” are assigned to the third row thereof, and the rest are assigned to the last row thereof. More specifically, alphabets “A”, “B,” and “C” are assigned to L-K11, F-K11, and R-K11, respectively, “D,” “E,” and “F” are assigned to L-K12, F-K12, and R-K12, respectively, and “G” are assigned to L-K13. In the next row of the keys 10, “H,” “I,” and “J” are respectively assigned to L-K21, F-K21, R-K21, “K,” “L,” and “M” are assigned to L-K22, F-K22, and R-K22, respectively, and “N,” “O,” and “P” are assigned to L-K23, F-K23, and R-K23, respectively. In the next row of such keys 10, “Q,” “R,” and “S” are assigned to L-K31, F-K31, and R-K31, respectively, and “T,” “U,” and “V” may be respectively assigned to L-K32, F-K32, and R-K32. In the final row of the keys 10, “W,” “X,” and “Y” are assigned to L-K41, F-K41, and R-K41, respectively, and “Z” are assigned to L-K42. Symbols such as the comma, acclamation mark, question mark, and period may be assigned to any blank sections or parts such as, e.g., F-K13, F-K33, R-K33, and R-K43, respectively. Another key arrangement of the panel (C) is generally similar to that of the panel (B), except that at most two alphabets are assigned to each key of the third and fourth rows of the keys 10. Another key arrangement of the panel (D) is also similar to that of the panel (B), except that alphabets “V” and “Z” are assigned to the sections or parts different from those of the panel (B).

FIG. 5C is top views of keys defining four sections or parts which are assigned according to yet another exemplary arrangement of characters according to the present invention. It is appreciated that the numerals from 0 to 9 and symbols such as “*” and “#” are assigned similar to those of FIG. 5A in all exemplary embodiments of this figure.

In the embodiment of the panel (A), alphabets are arranged based on an arrangement which is adopted by conventional keyboards and which is referred to as the “Qwert” arrangement. Therefore, alphabets “Q,” “W,” and “E” may be assigned to L-K11, F-K11, and R-K11, respectively, “R,” “T,” and “Y” may be assigned to L-K12, F-K12, and R-K12, respectively, and “U,” “I,” and “O” may be assigned to L-K13, F-K13, and R-K13 respectively. In the next row, “A,” “S,” and “D” are respectively assigned to L-K21, F-K21, R-K21, “F,” “G,” and “H” are assigned to L-K22, F-K22, and R-K22, respectively, and “J,” “K,” and “L” are assigned to L-K23, F-K23, and R-K23 respectively. In the next row, “Z,” “X,” and “C” are assigned to L-K31, F-K31, and R-K31, respectively, “V,” “B,” and “N” are assigned to L-K32, F-K32, and R-K32, respectively, and “M” is assigned to L-K33. An alphabet “P” which is disposed in the first row of alphabets of the conventional keyboards may be disposed in one of any blank sections or parts and, in this example, assigned to C-K43. Symbols such as the comma, period, star, sharp mark, and question mark may be assigned to other blank sections or parts such as, e.g., F-K33, R-K33, C-K41, C-R43, and R-K43, respectively. Another key arrangement of the panel (B) is generally similar to that of the panel (B), except that the alphabet “P” is assigned to R-K33 and various symbols may also be assigned to different sections or parts. In another key arrangement of the panel (C), alphabets are similarly assigned according to the “Qwert” arrangement but to the second, third, and fourth rows of the keys 10, contrary to the first, second, and third rows thereof as exemplified in the panels (A) and (B). The alphabet “P” is assigned to R-K13, and symbols may be assigned to any of blank sections or parts thereof. Another key arrangement of the panel (D) may generally be similar to that shown in the panel (C), but includes more symbols assigned thereto according to an arrangement of such symbols adopted by the “Qwert” keyboards.

FIG. 5D is top views of keys defining four sections or parts assigned according to yet another exemplary arrangement of characters according to the present invention. It is to be understood that the numerals from 0 to 9 and symbols such as the star and sharp signs are assigned similar to those of FIG. 5A in the exemplary embodiments of the panels (A) and (B), but such numerals and symbols are assigned in a reverse order in the exemplary embodiments of the panels (C) and (D).

In the embodiment of the panel (A), the key assembly includes twelve keys 10 arranged to be fit into positions of elements of a 4×3 matrix, where two keys (i.e., K31 and K33) may be arranged to define a single center section 12C and four side sections 12S thereon, while each of the rest of such keys may be arranged to have thereon a single center section 12C and only three side sections 12S. Accordingly, in the first row of the keys 10, alphabets “A,” “B,” and “C” are assigned to L-K12, C-K12, and R-K12, respectively, and “D,” “E,” and “F” are assigned to L-K13, C-K13, and R-K13, respectively. In the next row, “G,” “H,” and “I” are assigned to L-K21, C-K21, and R-K21, respectively, “J,” “K,” and “L” are assigned to L-K22, C-K22, and R-K22, respectively, and “M,” “N,” and “O” are assigned to L-K23, C-K23, and R-K23, respectively. In the next row, “P,” “Q,” “R,” and “S” are assigned to L-K31, C-K31, R-K31, and B-K31, “T,” “U,” and “V” are assigned to L-K32, C-K32, and R-K32, respectively, and “W,” “X,” “Y,” and “Z” are assigned to L-K33, C-K33, R-K33, and B-K33, respectively, where “B” may refer to a fourth section or part of the key 10. Another key arrangement of the panel (B) is generally similar to that of the panel (A), but does not include any key with four side sections 12S. Accordingly, such a key arrangement has to assign the alphabets “Y” and “Z” to L-K41 and C-K41, respectively. As manifest in these figures, other characters may also be assigned to any side sections or parts of the keys K11, K41, K42, and K43.

In the embodiments of the panels (C) and (D), ten numerals from 9 to 0 and two symbols such as the star and sharp marks are assigned to center sections or parts of the twelve keys, e.g., 1 to C-K11, 2 to C-K12, 3 to C-K13, 4 to C-K21, 5 to C-K22, 6 to C-K23, 7 to C-K31, 8 to C-K32, 9 to C-K33, 0 to C-K42, the star to C-K41, and the sharp to C-K43. Such an arrangement may be commonly adopted by numeric pads of the conventional keyboards. Similar to the foregoing, more characters may further be assigned to other sections or parts of such keys 10. Other alphabets and/or symbols may also be arranged to remaining sections or parts of the keys 10. For example, a key arrangement exemplified in the panel (C) is generally similar to that of the panel (C) of FIG. 5A, while another key arrangement exemplified in the panel (D) is generally similar to that of the panel (D) of FIG. SC. Other arrangements are also possible with the reverse numeral arrangements exemplified in these panels (C) and (D).

FIG. 6A is top views of keys defining five sections or parts which are assigned according to an exemplary arrangement of characters according to the present invention. The panels (A) and (B) describe a nomenclature for an exemplary arrangement of twelve keys according to a 4×3 matrix (i.e., a matrix with four rows and three columns), where each key may define five sections or parts on its top and/or side surfaces. Each key may be designated by the nomenclature described in conjunction with FIGS. 5A to 5D, a center section 12C or part 13C of the key may be represented by “C,” and four side sections 12S or parts 13S may be represented by “L (left),” “F (front),” “R (right),” and “B (back).” Moreover, ten numerals from 0 to 9 and two symbols such as the star and sharp marks are assigned to center sections or parts of the twelve keys, e.g., 1 to C-K11, 2 to C-K12, 3 to C-K13, 4 to C-K21, 5 to C-K22, 6 to C-K23, 7 to C-K31, 8 to C-K32, 9 to C-K33, 0 to C-K42, the star to C-K41, and the sharp to C-K43. More characters may be assigned to other sections or parts of such keys which have not yet been assigned. It is to be understood that various key arrangements of this aspect of the present invention may be arranged to be similar to those for the keys defining four sections or parts thereon, for various keys of such an aspect of the invention which may define five sections or parts thereon may provide more sections or parts to be assigned with more characters. When desirable, however, various keys of this aspect of the invention may be arranged in different arrangements which may not be feasible with the keys defining only four sections or parts thereon.

A key arrangement exemplified in the panel (C) may generally be similar to that of the panel (C) of FIG. 5A. However, such an arrangement may provide more blank sections or parts such as R-K13, R-K23, R-K33, R-K42, L-K43, R-K43, and all other back sections or parts of the keys 10. Accordingly, such an embodiment may allow the user to assign more characters to any of those blank sections or parts. A key arrangement exemplified in the panel (D) may generally be similar to that of the panel (B) of FIG. 5B, while providing more blank sections or parts.

FIG. 6B is top views of keys defining five sections or parts which are assigned according to another exemplary arrangement of characters according to the present invention. Similar to those of FIG. 6A, exemplary key arrangements of the panels (A) to (C) may generally be similar to those of the panel (D) of FIG. 5C, the panel (A) of FIG. 5D, and the panel (C) of FIG. 5A, respectively. In addition to such embodiments, various sections or parts of such keys may also be redundantly assigned so that some frequently used characters such as numbers or vowels of alphabets may be assigned to more than one section or part of the same key or different key. For example and as exemplified in the panel (D) of this figure, such a redundant key arrangement may be similar to any of the above arrangements such as, e.g., that of the panel (C) of FIG. 5A. However, such a key arrangement may redundantly or repeatedly assign vowels which have been assigned to the keys of a given row to another key of the third column of the same given row. For example and in the first row, the vowel “A” is assigned to L-K11 and then again to B-K13, while the vowel “E” is assigned to C-K12 and again to R-K13. Similarly, in the second row, the vowel “I” is assigned to C-K21 and redundantly to B-K23. In the third row, the vowels “O” and “U” may be respectively assigned to L-K31 and L-K33 and repeatedly to B-K33 and R-K33. Because there is no vowel assigned to the last row, no redundancy is provided to such a row.

Configurational and/or operational variations and/or modifications of the above embodiments of the exemplary key assemblies which may incorporate at least one key having multiple sections and/or multiple parts also fall within the scope of this invention.

It is first appreciated that the foregoing arrangements of multi-section (or multi-part) keys and the foregoing assignments of various characters thereto are intended only for explanation of various aspects and/or their embodiments of this invention and, therefore, may not be interpreted to be limiting the scope of this invention. Therefore, the foregoing key arrangements and/or character assignments may be modified without departing the scope of the present invention.

For example, the numerals and/or selected symbols such as the star and sharp marks may be assigned to various sections (or parts) according to different arrangements. Accordingly, arranging one or more keys in a slightly different order may be plausible as long as each section (or part) of the keys may be able to receive the input force independently of the others. In addition, assigning various characters to such sections (or parts) in one of the foregoing sequences may also be possible while creating blank sections (or parts) in different locations of such keys. Furthermore, the foregoing key arrangements may be modified by incorporating a mixture of keys each defining a different number of such sections (or parts) thereon, each defining a different shape and/or size, and so on. The above key arrangements and/or character assignments may also be applied to other languages or symbols.

The multi-section or multi-part key of the present invention may be incorporated in any number. That is, in another example, the foregoing key arrangements may further be modified by incorporating more (or less) than twelve keys. For example, less than twelve (such as, e.g., eleven, ten, nine, eight or seven) keys may be used while defining multiple sections (or parts) thereon. Because of the less number of keys, such a key arrangement may be assigned with less characters. To overcome such a deficit, each key of such an arrangement may define more sections (or parts) thereon. In contrary, more than twelve (such as, e.g., thirteen, fourteen, fifteen, sixteen, seventeen, eighteen, nineteen or more) keys may be used while defining multiple sections (or parts) thereon. Because of such a larger number of keys, such a key arrangement may be assigned with more characters or, conversely, may have to define less sections (or parts) thereover to be assigned with a preset number of characters. When the number of keys does not correspond to twelve as exemplified herein, such keys may also be arranged in almost any arbitrary configuration, as long as such configuration may allow the user to apply the input force to each section (or part) of at least a substantial number of keys.

As described above, at least one character may be redundantly or repeated assigned to more than one section (or part). In one example, such a character may be assigned to multiple sections (or parts) of a single key, resulting in enlargement of the area representing such a character. In another example, such a character may be assigned to multiple sections (or parts) of different keys, thereby allowing the user to represent such a character by applying the input force to multiple positions of the key assembly.

In another aspect of the present invention, various key units may further be provided to include the foregoing multi-section (or multi-part) keys and to assist an user in selecting each character which may be assigned to different sections (or parts) of various keys thereof.

In one exemplary aspect of such an aspect of this invention, such a key unit may be arranged to include multiple recoil units each of which may be arranged to store at least a portion of mechanical energy of the input force applied by the user and then to release such a portion of energy when one of preset events may occur. More particularly, each of such recoil units may operatively couple with each section (or part) of the key such that each recoil unit may store the portion of energy of the input force while such a section (or part) may move from its rest position to its active position in response to the input force. Each recoil unit may then release the stored portion of such energy upon cessation of application of the input force to each section (or part). As described hereinabove, the multi-section (or multi-part) key of the present invention may be characterized by its location or position specificity. The recoil units of the key unit may similarly be location- or position-specific, i.e., each of such recoil units may substantially absorb such a portion of energy when the input force is applied to one section (or part) to which such a recoil unit may couple with. Accordingly, when the input force is applied substantially to only one section (or part) of the key, only one recoil unit coupling with such a section (or part) may substantially absorb and store such a portion of energy. In the meantime, other sections (or parts) of the same key may at most receive a very small portion of the input force and those recoil units coupling therewith may at most store only a negligible portion of the energy which is associated with the input force. When the input force ceases to be applied, the recoil unit may the release such a portion of energy and returns only one section (or part) of the key coupled thereto to its rest position. It is appreciated that such a feature does not apply to conventional keys which may not be location- or position-specific, i.e., such a conventional key may move in response to such input force regardless of which portion of the key may receive the input force. Various conventional articles may be utilized as such recoil units examples of which may include, but not limited to, springs, coils, and other articles or structures exhibiting elastic or recoil characteristics.

In another exemplary aspect of such an aspect of this invention, a key unit may be arranged to include multiple circuits each of which may be disposed in operative relation to each section (or part) of a key and arranged to be open and/or close at least a portion thereof in response to the input force applied thereto by the user. As described above, the multi-section (or multi-part) key of this invention may be characterized by its location or position specificity. Such circuits of the key unit may similarly be location- or position-specific, i.e., each of such circuits may be arranged to close at least a portion thereof when the input force is applied to one section (or part) to which such circuit may be coupled. Accordingly, when the input force is applied substantially to only one section (or part) of the key, only one circuit coupling with such a section (or part) may close at least a portion thereof, thereby getting capable of generating an electric signal representing such a section (or part) and a specific character assigned to such a section (or part). In the meantime, other sections (or parts) of the same key may at most receive a very small portion of the input force and those circuits coupling therewith may not be able to close their portions and may not generate any other electric signals. It is appreciated that this feature does not apply to conventional keys which are not location- or position-specific, i.e., the conventional key generally includes a single circuit thereunder and such a circuit may also be closed in response to such input force regardless of which portion of the key may receive such input force. Such circuits may be disposed in various regions near the sections (or parts) of the key, e.g., under such sections (or parts), next to or lateral to such sections (or parts), and so on. It is appreciated that precise location of such circuits may not be material to the scope of the present invention as long as each of such circuits may close a portion thereof when the input force is applied to a specific section (or part) to which such a circuit may be coupled.

In another exemplary aspect of such an aspect of this invention, a key unit may be arranged to include multiple signal units each of which may operatively couple with each section (or part) of a key and arranged to generate specific electric signals in response to the input force applied thereto by the user. As described above, the multi-section (or multi-part) key of this invention may be characterized by its location and/or position specificity. Such signal units of the key unit may similarly be location- or position-specific, i.e., each of such signal units may be arranged to generate a preset electrical signal when the input force is applied at least substantially to one section (or part) with which such a signal unit may couple. Therefore, when the input force is applied substantially to only one section (or part) of the key, only one signal unit coupling with such a section (or part) may generate an electric signal representing such a section (or part) and a specific character assigned to such a section (or part). In the meantime, other sections (or parts) of the same key may at best receive a very small portion of the input force and those signal units coupling therewith may be arranged to not generate any signals. It is appreciated that this feature does not apply to conventional keys which are generally not location- or position-specific, i.e., the signal units of the conventional key are arranged to generate the signals in response to such input force regardless of which portion of the key may receive the input force.

It is appreciated that various configurational and/or operational features of the above aspects and/or their embodiments of the present invention may be used interchangeably. Accordingly, any of the above sections (or parts) of one exemplary key may be incorporated into another exemplary key. Similarly, any of the above keys of one exemplary key arrangement may be incorporated into another exemplary key arrangement. In addition, any feature of one exemplary character assignment may be applied to another exemplary character assignment It is also appreciated that various configurational and/or operational features of different aspects and/or embodiments of the present invention may be used in combination. Accordingly, a key arrangement may include some keys with three sections (or parts), other keys with four sections (or parts), and so on.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. An unitary key unit for selecting a plurality of different characters comprising:
an unitary body defining a plurality of exposed sections at least two of which are configured to be disposed in different areas of said body and to be assigned with different characters, wherein each of said at least two of said sections is configured to receive different input force applied by an user and to generate a movement from its rest position to its active position in response to said input force, thereby enabling said user to select only one of said characters but not to the other thereof by applying said input force to only one of said at least two of said sections but not to the other thereof.

2. The key unit of claim 1, wherein said body is configured to define one of two, three, four, and five of said sections thereon.

3. The key unit of claim 2, wherein only one of said sections is configured to be assigned with a single numeral, while each of the rest of said sections is assigned with one of a single alphabet and a single symbol.

4. The key unit of claim 1, wherein said body is configured to define an exposed surface thereon and wherein said at least two of said sections are configured to have at least one different property on said surface.

5. The key unit of claim 4, wherein said property is configured to include at least one of an angle of one of said at least two of said sections with respect to the other thereof, an inclination thereof, an elevation thereof, a texture thereof, a shape thereof, a number of sides thereof, a number of vertices thereof, a size thereof, an orientation thereof, an exposed area thereof, a contour thereof, and a color thereof.

6. The key unit of claim 1, wherein said movement is configured to at least one of translate, pivot, and rotate at least a substantial portion of said key in response to said input force.

7. The key unit of claim 6, wherein each of said movement of said at least two of said sections is configured to move said key in a different direction.

8. The key unit of claim 1 further comprising at least two recoil units each of which is configured to couple with only one of said at least two of said sections, wherein each of said at least two recoil units is configured to store at least a portion of energy of said input force applied to said only one of said at least two of said sections and then to release said portion of said energy so as to return said only one of said at least two of said sections from its active position to its rest position upon cessation of application of said input force.

9. The key unit of claim 1 further comprising at least two signal units each of which is configured to couple with only one of said at least two of said sections, wherein each of said at least two signal units is configured to generate an electric signal when said input force is applied to said only one of said at least two of said sections but not to the other thereof, thereby enabling said user to manipulate each of said at least two of said sections and to provide said electric signals each representing said only one of said characters which is assigned to said only one of said at least two of said sections by said signal units.

10. A multi-part key unit for selecting a plurality of different characters comprising:
a plurality of parts configured to be clustered within a preset distance, wherein at least two of said parts are configured to be assigned with different characters and disposed in different areas of said key, wherein each of said at least two of said parts is configured to receive different input force applied by an user and to generate a movement from its rest position to its active position in response to said input force, thereby enabling said user to select only one of said characters assigned to said key through applying said input force to only one of said at least two of said parts and not to the other thereof.

11. The key unit of claim 10 comprising one of two, three, four, and five of said parts thereon.

12. The key unit of claim 10, wherein only one of said parts is configured to be assigned with a single numeral, while each of the rest of said sections is assigned with one of a single alphabet and a single symbol.

13. The key unit of claim 10, wherein each of at least two of said parts is configured to define one surface thereon and wherein each of said at least two of said parts is configured to have at least one different property on said surface thereof.

14. The key unit of claim 10, wherein said property is configured to include at least one of an angle of one of said at least two of said parts with respect to the other thereof, an inclination thereof, an elevation thereof, a texture thereof, a shape thereof, a number of sides thereof, a number of vertices thereof, a size thereof, an orientation thereof, an exposed area thereof, a contour thereof, and a color thereof.

15. The key unit of claim 10, wherein said movement is configured to at least one of rotate, pivot, and translate in response to said input force.

16. The key unit of claim 10, wherein each of said movement of said at least two of said parts is configured to move said key in a different direction.

17. The key unit of claim 10 further comprising at least two recoil units each configured to couple with only one of said at least two of said parts, wherein each of said at least two recoil units is configured to store at least a portion of energy of said input force applied to said only one of said at least two of said parts and then to release said portion of said energy so as to return said only one of said at least two of said parts from its active position to its rest position upon cessation of application of said input force.

18. The key unit of claim 10 further comprising at least two signal units each configured to couple with only one of said at least two of said parts, wherein each of said at least two signal units is configured to generate an electric signal as said input force is applied to said only one of said at least two of said parts but not to the other thereof, thereby enabling said user to manipulate each of said at least two of said parts and to provide said electric signals each of which represents said only one of said characters assigned to said only one of said at least two of said parts by said signal units.

19. A method of selecting a plurality of characters by an unitary key comprising the steps of:
defining a plurality of exposed sections on said key;
assigning each of at least two of said sections with a different character; and
selecting each of said characters which is configured to be assigned to each of said at least two of said sections by applying input force only to said one of said at least two of said sections but not to the other thereof, without requiring an user to apply another input force to another key.

20. The method of claim 19 further comprising the step of consecutively applying said input force to different ones of said at least two of said sections, thereby selecting different ones of said plurality of said characters assigned to said key, without cooperation of any other key.
